(19) United States
(12) Patent Application Publication
(10) Pub. No.: US 2017/0233966 A1
(43) Pub. Date: Aug. 17, 2017

(54) INTEGRATED MARINE BARRIER

(71) Applicant: INTEGRATED MARITIME SOLUTIONS LTD., KIBBUTZ BEIT OREN (IL)

(72) Inventors: Omri BEN ELIYAHU, Bnei Dror (IL); Ayalom Menahem ROITEMBERG, Kibbutz HaHotrim (IL); Guy AYALON, Kibbutz Beit Oren (IL); Elyakim BEN-HAKOUN, Ramat Yishai (IL)

(21) Appl. No.: 15/502,859

(22) PCT Filed: Jul. 6, 2015
(86) PCT No.: PCT/IL2015/050697

§ 371 Date: Feb. 9, 2017

Related U.S. Application Data
(60) Provisional application No. 62/021,217, filed on Jul. 7, 2014.

(51) Int. Cl. E02B 15/08; E02B 15/04; F41H 11/00; E02B 15/10

(52) U.S. Cl. CPC E02B 15/0864; E02B 15/106; E02B 15/0885; E02B 15/041; F41H 11/00; G08B 13/08

(57) ABSTRACT

A submergible marine barrier protecting marine installations in a protected zone against intrusion and providing a containment barrier against spread of floating spills or bodies. The body of the barrier is supported above water by a main body thus preventing intrusion and containing floating spillage. A weight in main body keeps the barrier upright, and a rigid floatation chamber in the main body keeps it afloat when full of air. A skimming pipe collects floating pollution. Flooding the floatation chambers causes the barrier to submerge allowing access to the protected zone and protecting the barrier from storms. Body, main body, and floatation chambers are made of extruded material with flotation properties (e.g. plastic pipes). Floatation chambers are connected by air hoses and have air venting tubes at their bottom. Sensors detect approaching intruders and pollution, while spikes, barbed-wire and diver-net or any known barrier are used to stop them.

### FIELD OF THE INVENTION

The present invention relates to an apparatus, system and method for providing protection to marine installations and assets against intrusion as well as providing barrier against spread of floating spill while allowing access and providing bad weather serviceability by submerging the barrier.

### BACKGROUND OF THE INVENTION

It is often desired to protect marine facilities for preventing contamination from entering the waters near the marine facilities, or to prevent contamination from escaping the water near the marine facilities to the open sea. Some marine facilities may further require intrusion deterrent barrier for preventing unauthorized access to the facility.

Some of these marine facilities may be situated in open and deep waters such that erecting walls around them is not a practical solution.

Floating boom systems are known in the art and are used for contaminant containment, whether oil spill or debris.

Oil spills are considered pollutant posing considerable risk of destruction marine and coastal environment. Potential contamination risk can be caused from verity of sources such as: gas and coal terminals, anchorages (marinas), channels and canals systems, port activities or any other marine infrastructures. Risk of contamination is high, due to common operational or engineering failures.

Today, sea pollution treatment is done by special response teams. The equipment needed for treating pollutants is held by the marine enterprises, or by a contractor assigned to this task and equipped with specialized equipment suitable. In most places, the existing equipment is enough for a small-scale to moderate response, and the effectiveness of the response depends on weather conditions and the time it takes to mobilize the equipment to the effected site.

Past experiences show that when a large scale marine pollution event occurred, there is almost no way to block the pollution and prevent it from affecting the shore and further harming the environment. In addition, past experiences show that even in a local event, the existing equipment most of the time can block and handle no more than 20-25% of the pollution.

In recent years, concerns about the security of marine energy installations include not only accidents and natural effects such as earthquakes and storm, but intentional malicious acts such as terrorism and cyber-attacks. Floating Production Storage and Offloading vessels (FPSO), Conventional Buoy Mooring (CBM), Multi-Buoy Moorings (MBM), Single Point Mooring (SPM) and offshore power plants are a common in many countries and all may be subject to attack.

States dependency on oil and gas imports/export is increasing, as are the energy needs of rising powers. The political, economic and security challenges surrounding of state energy supply are profound.

All marine containment enclosure have a common problem: if there is a need to provide access into and/or out of the restricted region within a body of water, it is required to allow partial temporary opening of the boom system to allow for movement of such traffic. By way of example, the need for traffic may come from the need to allow for boat traffic when the boom system separates a mooring basin from the open body of water.

General background information regarding marine barriers may be found in the following references:

WO2011045791A1 Marine barrier system for harbour protection
U.S. Pat. No. 3,998,060 Barrier for water carried pollutants
U.S. Pat. No. 4,084,380 Oil fence
U.S. Pat. No. 4,129,989 Ballasted floating barrier boom
U.S. Pat. No. 4,280,438 Boat hull anti-fouling shroud
U.S. Pat. No. 4,484,836 A Pneumatic spar sediment control curtain
U.S. Pat. No. 4,693,200 Apparatus for enclosing a boat hull
U.S. Pat. No. 5,064,309 Dockside spill containment system
U.S. Pat. No. 5,102,261 Floating containment boom
U.S. Pat. No. 5,154,537 Barrier curtain
U.S. Pat. No. 5,310,283 Floating barrage
U.S. Pat. No. 5,312,204 Floating barrier apparatus
U.S. Pat. No. 5,346,329 Floating barrier method and apparatus
U.S. Pat. No. 6,854,927 Containment boom
U.S. Pat. No. 7,134,807 Submersible boom gate
U.S. Pat. No. 7,775,171 Flexible fluid containment vessel featuring a keel-like seam
EP1735226A1 Submersible boom gate
WO1991000393A1 Floating boom
WO1991007546A1 Floating barrage
WO1992001119A1 Dockside spill containment system
WO2003080938A1 Device of a fender system
WO2011073542 Submerged devices suitable for instantaneous surface deployment of various means for useful activities, in particular for protecting port facilities and the environment
CN202194110(U) Lifting controllable type water break

### JP2006249914(A) Tidal Wave Breakwater

### JPS59154209(A) Breakwater Having Multi-Stage Gas Compression Function

### JPS5733608(A) Harbor Structures As Breakwater Or The Like

U.S. Pat. No. 3,779,020(A) Immersible Oil Fence Assembly
US2005042029(A1) System and apparatus for rapidly installed breakwater

### KR100955749(B1) Floating Storm Surge Barrier

### CA2140987(A1) Method And Apparatus For Containment Of Oil And Other Pollutants

### WO9411582(A1) Flexible Dam

### SUMMARY OF THE INVENTION

The present invention relates to an apparatus, system and method for providing protection to marine installations and assets against intrusion as well as providing barrier against spread of floating spill while allowing access to the marine installation by submerging at least parts of the barrier, and further providing bad weather serviceability by submerging the entire barrier.

The present invention discloses apparatuses, systems and methods for providing protection to marine installations and assets from outside such as: assisting marine navigation and improving marine safety, protection against sabotage, intrusion, stowaways and thefts. Additionally, the present invention discloses apparatuses, systems and methods for providing protecting the environment such as protection barrier (pre booming) against spread of floating spill in a the form of contaminant containment system capable of blocking the spread of a wide variety of petroleum and plant-based fuel products such as: crude oil, diesel and bio-diesel fuel, heavy fuel oils asphalt and bitumen etc.). The invention further allows ongoing operational access and providing bad weather serviceability by submerging the barrier.

The current invention is aimed to provide an integrated solution of a floating marine barrier that provide a surface barrier against intrusion of swimmers, divers and vessels to the protected zone as well as a barrier against spread of floating spill. Additionally, the barrier includes means to collect floating spilled liquid contaminants spreading from within the protected zone.

The barrier can be in state of floatation, but may be partially of fully submerged if needed to allow passage of vessels, for example operational ships, into and out of the protected zone. Optionally, the barrier may be submerged to protect it from being damaged during situation of stormy weather, bad sea conditions, and for security needs.

The barrier may be made of commercially available pipes made of plastic (or other material). Such pipes are available at long sections and thus large size barriers may be constructed economically. The barrier may thus be made of a single long section made of such available pipes. Alternatively, sections of the barrier may be assembled to long stretches to protect large installations such as harbors and oil rigs, or in water with high environmental value (such as coral marine nature reserve, etc.). Optionally the plastic pipes have natural buoyancy.

The barrier may be anchored at shallow or deep waters such as oceans, lakes, rivers, reservoirs or any other body of water. In harbors and dockside protection, the barrier may be anchored to the shore, dock, or breakwater at one or both ends (or the middle), and in addition it may be anchored to seafloor. To create a secure zone around a marine asset away from the shore, the barrier may be constructed as a closed zone around the marine asset. Assets in other bodies of water such as bays, lakes and rivers may be similarly protected.

Optionally the barrier is positioned at a distance from the asset to be protected wherein the distance is large enough that a hostile party outside the barrier is out of range for engaging the asset. For an oil rig in deep waters, this range may be few hundreds meters, and thus the need for a barrier that may be economically constructed to provide protection over a perimeter of few kilometers.

Optionally, few concentric barriers may be constructed, optionally each with different characteristics. For example inner barrier may provide human and/or spillage protection, while the outer barrier provide protection against intruders.

For example, an inner barrier may be placed at short range from an oil rig, aimed mainly to stop swimmers and light vessels (such as rubber boats, jet-ski and floating explosive devices) from entering, and to stop and collect floating spill liquid contaminants from spreading from the rig into the open sea. An outer barrier, aimed to detect, alert, stop (or at least delay) approaching boats may be placed further away from the rig.

Optionally, the barrier may be towed floating or in near neutral buoyancy state from one place to another for installation or relocation.

The barrier may comprise markings such as warning (for example “do not enter” or “stay away” sign, etc.), underwater lighting systems, bells or horns (such as dive alert air horns) for audible warning (to be used for example at night and in fog condition), flags lights, and radar reflectors to warn marine traffic against colliding with the barrier. Additionally, the barrier may comprise a sensor or a plurality of sensors for sensing approaching intruders (for example swimmers, divers, vessels, etc.) at distance or when attempting to overcome the barrier. Such sensors may include one or few of: radar, sonar, optical (beam crossing or cameras (such as visible, night vision, IR or thermal cameras), microphones, magnetic sensors, or contact sensors. Activation of a sensor may activate an alarm at the costal station and/or on the marine assets. Sensor activation may automatically deploy defense or warning devices and system such as turning on search lights, floating submersed sections of the barrier, calling backup tropes or law enforcing agencies, etc.

Optionally, the barrier may comprise an external rapping, for example made of fabric such as polyester reinforced PVC (UV and hydrocarbons resistance strength) for rain and sun protection or for concealing its internal structure, External textual and pictorial massages such as warnings, logos and advertisements may be displayed on the external rapping. The external rapping may be exchanged when damaged or faded.

Pollution sensors may automatically activate a spill skimming system, or alert a situation room for the need to take action. Spill sensors may be based on chemical sensors, thermal sensors, ultrasonic sensors, optical water clarity and the likes. In some installations, the barrier may provide protection against spill entering and/or exiting the protected zone. Such protection may be needed around water intakes of power stations, refineries, pipelines, oil and gas rigs, Floating Production Storage and Offloading vessels (FPSO), Conventional Buoy Mooring (CBM), multi-buoy moorings (MBM), single point mooring (SPM), water distillation facilities or any other homeland security infrastructure. In these cases, spill skimming intake may be located at the outer side, the inner side, or both sides of the barrier.

Optionally, an anti diver net in the form of fiber optic fence, skirt, curtain, or metallic net may be connected to the barrier, spanning the distance to the bottom or to a depth below the safe diving zone.

Generally, the barrier will be anchored to the seabed in a way that withstands the effects of waves, wind and tidal forces assume to be present at the barrier's location. Mooring means such as anchors, weights, marine sinkers, polls driven into the seabed, or other anchoring means may be used.

The barrier has a barrier body that in floating state is at least partially above the water level and is used as intrusion barrier and may act as a contamination contaminant barrier.

The barrier optionally has at least one contaminant skimming pipe having a plurality of contaminant skimming opening that in floating state are just below, or at the water level and are used for pumping contaminated water to a contamination separation facility that separate and store the contaminants and return the cleared water to the open sea,

The barrier has a main body that in floating state is substantially or entirely below the water level and provides bulk and stability to the barrier. Within the main body is a floating chamber (or a plurality of floating chambers) that control the floatation of the barrier and provide buoyancy to stabilize the barrier in an upright position, The main body (apart from the floating chamber(s)) is full of water, and thus has a considerable mass. As a result of this mass the barrier is hard to push around. At the bottom of the barrier (inside the main body, outside the main body or both inside and outside the main body, is a weight (or a plurality of weights), for example in a form of a chain, steal pipe, concrete, and the likes, that ensures submerging the barrier when the floating chamber(s) is (are) filled with water, and provide ballast to stabilize the barrier in an upright position. Alternatively or additionally, floating chamber (or a plurality of floating chambers) may be placed outside the main body.

The barrier body may be made smooth and slippery as not to provide handholds and foothold for intruder coming from outside or optionally from the inside of the secure zone. Additionally, the top of the barrier body may comprise anti-climbing means such fences, barriers, barbed wire, barbed wire spirals or spikes, electrical fence, or water cannons to repel intruders. To operate water cannons, the barrier may comprise hoses connected to water pumps outside the barrier, or may comprise pumps.

To submerge the entire barrier, or a section of the barrier, water is pumped into or allowed to fill the floatation chamber(s) and the barrier submerges below the water level. In shallow waters, the barrier may sink and rest on the seafloor.

The floating chambers as a non-limiting example can be made of HDPE, PEX, PV, or other similar thermoplastic materials and the likes or any other body with buoyant ability (flexible inflatable sacks etc.)

In deep water, an optional system of intermediate floats keeps the barrier above the sea floor at a safe depth which allows vessels passing over the barrier into and out of the secure zone. The optional system of intermediate floats my further be used for keeping the barrier safe from effects of stormy weather, bad sea conditions, or for other reasons such as security need, but prevents parts of the barrier from sinking into the depth that may harm its components.

Alternatively, a system of depth limiting weights prevents parts of the barrier from sinking to depth that may harm its components. The system of depth limiting weights may also be used in shallow water.

According to an exemplary embodiment of the current invention, a marine barrier is provided, the marine barrier comprises: a body, said body is at least partially above water-level when the marine barrier is in floating state; a main body, connected to said body and supporting said body; at least one weight connected to the bottom of said main body and keeping the marine barrier upright; and at least one floatation chamber at least partially full of gas when the barrier is in floating state, wherein the marine barrier is configured to at least partially submerge when water enters said at least one floatation chamber when the marine barrier is in submerged state and to return to floating state when gas is pumped into said at least one floatation chamber displacing water within said at least one floatation chamber, and wherein in said at least one floatation chamber is non-inflatable.

In some embodiments the least one of: said body, said main body, and said at least one floatation chamber are made of extruded plastic material.

In some embodiments at least one of: said body, said main body, and said at least one floatation chamber are made of plastic material having buoyancy.

In some embodiments at least one floatation chamber is rigid or semi-rigid.

In some embodiments at least one floatation chamber further comprises a venting tube connected to the lower part of said at least one flotation chamber for venting excess gas when gas is pumped into said at least one floatation chamber.

In some embodiments the main body has openings to allow water and gas in and out of said main body.

In some embodiments the body has openings to allow water and gas in and out of said main body.

In some embodiments the water used for flooding said at least one floatation chamber is water from the body of water where the marine barrier is positioned, and the gas used for discharging said water from said at least one floatation chamber is air.

In some embodiments the marine barrier, further comprises at least one valve for allowing water into said at least one floatation chamber for submerging the marine barrier.

In some embodiments the marine barrier further comprises a plurality of multiple floatation chambers.

In some embodiments at least two of said plurality of floatation chambers are attached to the marine barrier externally, and both sides of said main body.

In some embodiments at least two of said plurality of floatation chambers are placed internally to said main body.

In some embodiments at least one of said plurality of floatation chambers is at least partially filled with non-fluid lighter than water material.

In some embodiments the non-fluid lighter than water material is selected from the list consisting of: foam, closed-cell rigid foam, gas filled bubbles.

In some embodiment, when in floating state the marine barrier prevents floating spillage and floating debris from traversing the marine barrier.

In some embodiments the marine barrier further comprises at least one skimming pipe having a plurality of contaminant skimming opening for collecting floating contamination when the barrier is in said floating state.

In some embodiments at least one skimming pipe is connected to a Contamination Treatment Facility.

In some embodiments controlling the amount of water in said at least one floatation chamber is used for controlling the floatation of said marine barrier such that said at least one skimming pipe is substantially at water level while pollution is collected bay said at least one skimming pipe.

In some embodiment at least one skimming pipe is further used for dispensing pollution treatment material.

In some embodiments the main body is full of water when the marine barrier is at floating state such that the marine has a considerable mass and as a result of this mass the marine barrier is hard to push around.

In some embodiments the marine barrier is configured to perform one of: detect, stop, delay, hinder and prevent intruders from traversing the marine barrier while the marine barrier is in floating state, while allowing floating bodies to traverse the marine barrier while at least part of the marine barrier is in submerged state.

In some embodiments the body of the marine barrier further intrusion preventing devices selected from a group consisting of: anti diver net, spikes, barbed wires, fence, slippery walls, warning signs and active intrusion preventing devices selected from the group consisting of: water cannon, horns and noise blasting devices.

In some embodiments the marine barrier is further having a fence connected to said body of said marine barrier, wherein at least one section of said fence is attach to a weight system via a cable, wire or a rope that ensures that said at least one section of said fence is in state of standing erect when the marine barrier is in floating state.

In some embodiments the intruders are selected from the group consisting of: swimmers, divers, boats, light marine vessels, and jet-skis.

In some embodiments the marine barrier further comprises active warning devices selected from the group consisting of: beacons, lights, audio device, energy pulse device and horns.

In some embodiments the marine barrier, further comprises intruder sensing devices selected from the group consisting of: cameras, radars, beam crossing sensors, microphones, contact sensors, and sonar.

In some embodiments the weight is selected from a group consisting of: a metal chain, a metal cable, and a plurality of weights strung a rope or a cable.

In some embodiments the weight is weaved in and out of said main body.

In some embodiments the weight is internal to said main body of the barrier.

In some embodiments the weight is external to said main body of the barrier and connected to the bottom of said main body in a plurality of places along the marine barrier.

In some embodiments weight further provides tensile strength to the marine barrier.

In some embodiments the marine barrier, is anchored with at least two anchor lines.

In some embodiments at least two anchor lines are connected to the marine barrier with a clamp.

In some embodiments the marine barrier is having a plurality of clamps, wherein at least one clamp is connected to an adjacent clamp to spread the tension applied to marine barrier.

In some embodiments at least two anchor lines are connected to said weight.

In some embodiments the weight is a metal chain.

In some embodiments at least two anchor lines are connected to a mooring system.

In some embodiments the marine barrier is anchored to land at least at one end of the marine barrier.

In some embodiments at least two anchor lines are anchored to the seafloor.

In some embodiments the marine barrier further comprises at least one depth limiting weight connected to the bottom of the barrier at the end of at least one submerging line,

wherein the weight and buoyancy of the marine barrier is such, that when in submerged state, the marine barrier would stop descending when said at least one depth limiting weight rests on the seafloor.

In some embodiments depth limiting weight is one of: a heavy metal chain, a heavy metal cable, or a plurality of weights strung on a rope, cable or a chain.

In some embodiments the marine barrier further comprises at least two intermediate buoys anchored to the seafloor, wherein each of said at least two anchor lines connected to a corresponding one of said at least two intermediate buoys, such, that when in submerged state, the marine barrier would stop descending and would stay suspended by said at least two anchoring lines above the seafloor.

In some embodiments the marine barrier further comprises a control unit for controlling the state of the marine barrier.

In some embodiments the control unit is used for submerging at least one selected section of the marine barrier such that said at least one selected section of the marine barrier is used as a controlled entrance to a protected zone enclosed by the marine barrier.

In some embodiments the control unit is used for submerging the marine barrier to protect the marine barrier from bad sea conditions.

According to another exemplary embodiment of the current invention, a multi-barrier system for protecting marine assets is provided, the multi-barrier system comprises: an inner marine barrier, poisoned to create an inner protected zone around the marine asset; and an outer marine barrier, positioned distally from said inner marine barrier to create an outer protected zone around said inner marine barrier, wherein said inner marine barrier and said outer marine barrier provide protection to the marine asset, and are capable to at least partially submerge below water level.

According to another exemplary embodiment of the current invention, a method for providing protection to marine installations and assets is provided, the method comprises the steps of: performing seafloor analysis by bathymetric survey; performing oceanographers' features survey such as: currents, wave, wind, salinity, and temperature; performing underground seabed analysis, designing a marine barrier according to data gathered in previous steps; installing mooring system; connecting a marine barrier to said mooring system; connecting said marine barrier to the electro mechanical control system; connecting said marine barrier to pneumatic unit capable of controlling the buoyancy of said marine barrier; adjusting sensors installed on said marine barrier; adjust active warning devices installed on said marine barrier; and adjust intrusion preventing devices installed on said marine barrier.

In some embodiments the method further comprises the step of connecting said barrier to at least one of: a skimming pipe, skimming machinery and a skimming element.

In some embodiments the method further comprises the step of connecting a weight element to the bottom of said marine barrier.

In some embodiments the method further comprises the step of connecting said marine barrier to intermediate buoys used as anchoring reference points.

In some embodiments the marine barrier is installed in an environment selected from the group consisting of: ocean, open sea, offshore, near shore, river, lake, canal, harbor, marina, near a dock, near a jetty, around an oilrig, and around a mooring system,

In some embodiments the method further comprises the step of connecting an external air source to an operated lifting element in said marine barrier.

In some embodiments the method further comprises the step of connecting an internal air source to an operated lifting element in said marine barrier.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

The terms “comprises”, “comprising”, “includes”, “including”, and “having” together with their conjugates mean “including but not limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

In discussion of the various figures described herein below, like numbers refer to like parts. The drawings are generally not to scale. For clarity, non-essential elements were omitted from some of the drawing, or are not marked with numbers in some of the drawings.

In the drawings:

FIG. 1A schematically depicts a top view of a marine barrier installed at a dockside according to an exemplary embodiment of the current invention.

FIG. 1B schematically depicts a top view of a marine barrier installed in open waters according to an exemplary embodiment of the current invention.

FIG. 1C schematically depicts a top view of a marine barrier installed in open waters according to another exemplary embodiment of the current invention.

FIG. 1D schematically depicts a top view of two marine barriers installed in open waters creating an inner protected zone and an outer protected zone according to another exemplary embodiment of the current invention.

FIG. 2A schematically depicts a side cross sectional view of a marine barrier in floating state according to an exemplary embodiment of the current invention.

FIG. 2B schematically depicts a side cross sectional view of a marine barrier having multiple floatation chambers in floating state according to an exemplary embodiment of the current invention.

FIG. 2C schematically depicts a side cross sectional view of a marine barrier having contamination skimming pipes, and stabilizing floatation chambers on both side and further comprising divers net and chain as a weight according to another exemplary embodiment of the current invention.

FIG. 3A schematically depicts a side cross sectional view of a marine barrier installed in shallow water, in floating state according to an exemplary embodiment of the current invention.

FIG. 3B schematically depicts a side cross sectional view of a marine barrier installed in shallow water, in submerged state according to an exemplary embodiment of the current invention.

FIG. 3C schematically depicts a side cross sectional view of a marine barrier installed in deep water, in floating state according to an exemplary embodiment of the current invention.

FIG. 3D schematically depicts a side cross sectional view of a marine barrier installed in deep water, in submerged state according to an exemplary embodiment of the current invention.

FIG. 3E schematically depicts a side cross sectional view of a marine barrier installed in deep water, in floating state according to yet another exemplary embodiment of the current invention.

FIG. 3F schematically depicts a side cross sectional view of a marine barrier installed in deep water, in submerged state according to yet another exemplary embodiment of the current invention

FIG. 4A schematically depicts an isometric view of a section of marine barrier showing some details of its construction according to an exemplary embodiment of the current invention.

FIG. 4B schematically depicts an isometric view of a section of marine barrier using a chain as a weight according to another exemplary embodiment of the current invention.

FIG. 4C schematically depicts an isometric view of a section of marine barrier using a chain internal to the main body as a weight according to yet another exemplary embodiment of the current invention.

FIG. 5A schematically depicts a floatation chamber having air venting tubes according to an exemplary embodiment of the current invention.

FIG. 5B schematically depicts cross section of a marine barrier having an integrated body and outside floatation chambers according to an exemplary embodiment of the current invention.

FIG. 5C schematically depicts cross section of a marine barrier having an integrated body and internal floatation chambers according to an exemplary embodiment of the current invention.

FIG. 6 schematically depicts atop view of a marine barrier installed in a river according to an exemplary embodiment of the current invention.

FIG. 7 schematically depicts a top view of a marine barrier installed in an entrance to a harbor or a marina according to an exemplary embodiment of the current invention.

FIG. 8A schematically depicts a top view of a marine barrier installed around a narrow jetty according to an exemplary embodiment of the current invention.

FIG. 8B schematically depicts a top view of a marine barrier installed around a narrow jetty, protecting a large section of sea according to yet another exemplary embodiment of the current invention.

### DESCRIPTION OF THE PREFERRED EMBODIMENTS

The present invention relates to an apparatus, system and method for providing protection to marine installations and assets against intrusion as well as providing barrier against spread of floating spill while allowing access and providing bad weather serviceability by submerging the barrier.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The drawings are generally not to scale.

For clarity, non-essential elements were omitted from some of the drawings. A man skilled in the art will be aware that elements appearing in one drawing or disclosed within an embodiment may be added to other drawings and combined with other embodiments.

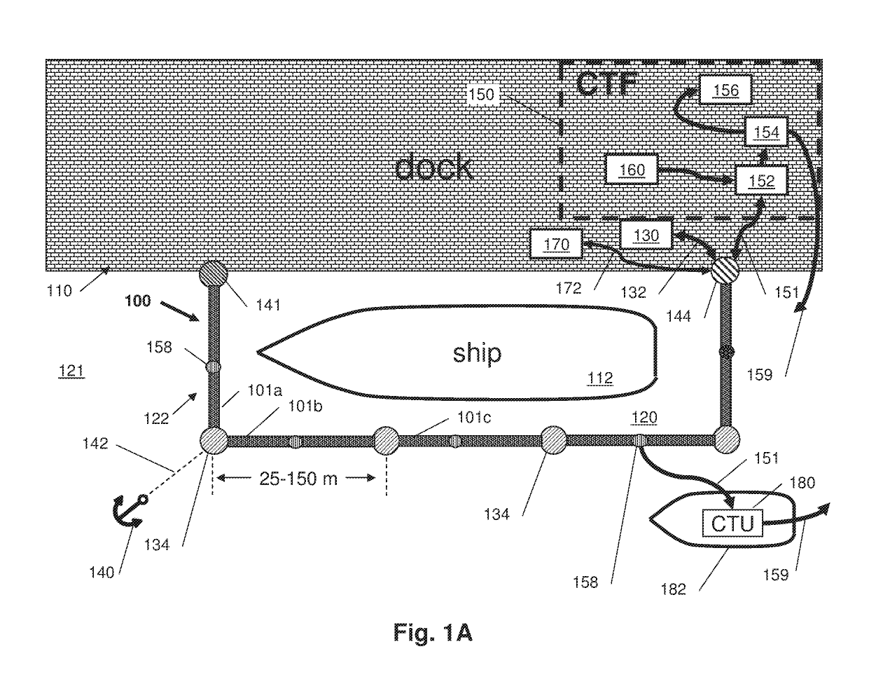

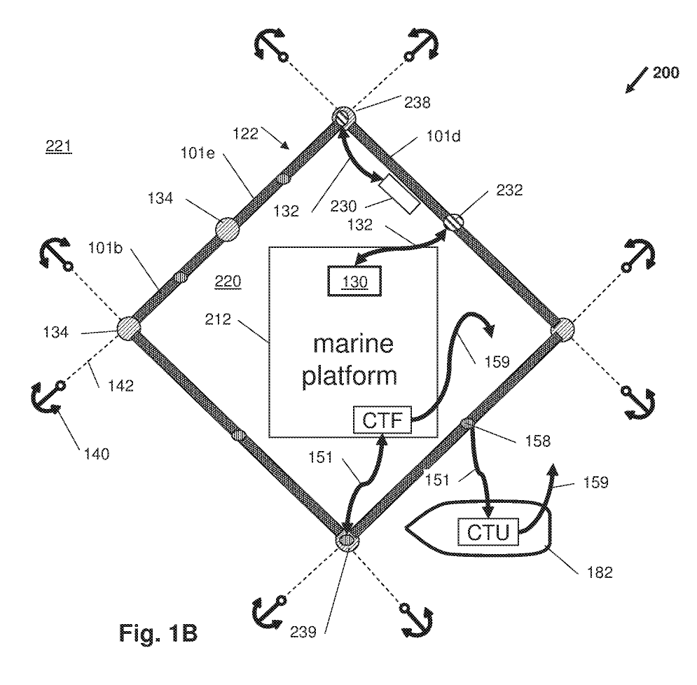

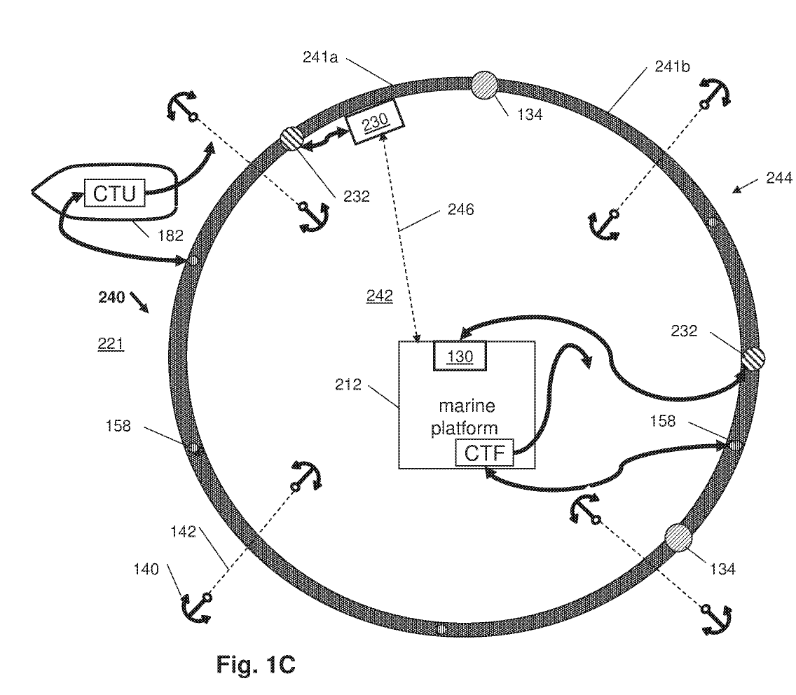

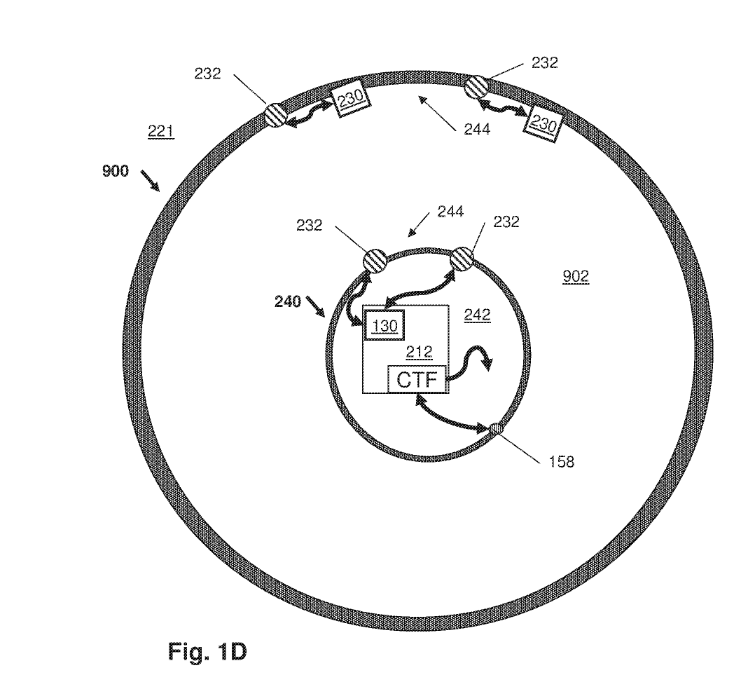

FIG. 1A schematically depicts a top view of a marine barrier installed at a dockside according to an exemplary embodiment of the current invention.

The general construction of a marine barrier 100 is seen here wherein the barrier 100 is erected to near a dock or a shore 110 for example to protect a ship or any other floating asset 112 and to contain any floating spill that may be leaking from the ship 112 other source of leakage source into the protected area 120. The rectangular shape of the barrier seen here is for demonstration only and other shapes may be used. The barrier structure may be sized to enclose more than one ship within the protected zone 120.

In the depicted exemplary embodiment the barrier is made of a plurality of sections (101a, 101b, etc). Sections 101x (herein “x” may stand for the letters a, b, c, etc.) may be of modular construction such that they can be linked to form a large length of barrier 100. However barrier 100 may comprise a single section.

The barrier 100 may be constructed to leave an opening or having a gate (not seen in this figure) through which the ship, small vessels, floating device or floating platforms may enter and exit the protected zone 120. Alternatively, a section 101x or few sections or all the barrier sections may be moved or submerge to allow the ship or other floating asset 112, other marine vessels, equipment, or small vessels (not seen in this figure) to enter and/or exit the protected zone 120. Optionally, one or few sections 101x of the marine barrier (in this example section 101a) are designated to be used as a controlled entrance 122. To allow the ship or other vessels to enter or exit the protected zone 120, the controlled entrance section(s) are submerged to a depth below the ship's keel, while the rest of the barrier remains afloat. Optionally, while the section(s) designated as controlled entrance 122 submerged to a depth below the ship's keel, other sections (for example sections adjacent to the section(s) designated as controlled entrance 122) are partially submerged or submerged obliquely to decrease the stresses and forces created in the barrier 100 during opening the controlled entrance 122. Location of the controlled entrance 122 is known and may be equipped with entrance regulation means such as additional sensors, buoys, marine blinkers, flags lights, radio transmitters, dive alert, air horn or any other audible alerts and automatic, remote controlled or manned checkpoint. Alternatively, the entire barrier is submerged.

In the depicted exemplary embodiment of dockside barrier, the floating and submerging control unit 130 (also termed “pneumatics 130”) that is used for floating and submerging the barrier 100, or a specific section or several sections 101x of the barrier 100 may be placed on the shore or dock 110 for easy access and maintenance. As will be disclosed in the next figures, floating chambers within or out the barrier may be filled with air to float the barrier, or flooded with water to cause it to sink underwater. The floating and submerging control unit 130 comprises air compressor and/or compressed air tanks or other gas tanks connected with air hoses 132 to the floatation chambers in the barrier. To float the barrier, compressed air forces the water out of at least one or a plurality of floatation chambers. To submerge the barrier, or a section of the barrier, air is released from the at least one or a plurality of floatation chambers and water is allowed to flood them, causing the barrier to submerge. Additionally or alternatively, water pumps in the floating and submerging control unit 130 may force water into one or a plurality of the floatation chambers to cause the section 101x to submerge. Water may be pumped into the floatation chamber via the air hoses 132 or via other (not seen here) hoses.

In some embodiments, the entire barrier may be floated and submerged together. This may be needed to let a ship depart, or to submerge the barrier to protect it against stormy weather.

Optionally, the barrier is constructed or controlled such that the barriers remain substantially horizontal during its decent from a floating state submerged state. Optionally, the barrier is constructed or controlled such that the barrier remains substantially horizontal during its ascent from submerged state to floating state.

In other embodiments, a section or some sections may be towed or pull apart while floating to allow access to the protected zone.

In yet another other embodiments, a section or some sections or even the entire barrier may be constructed to permanently float. This may be useful in a lake or a protected bay or other places where submerging the barrier to protect it against bad weather is not needed. In this case, the floating and submerging control unit 130 that is used for floating and submerging the barrier is not needed, or is not connected to the permanently floating sections. Optionally, floatation chambers which are not to be flooded may be filled with filling material, for example foam, preferably closed cell foam. Such filling material has the advantage of providing floatation even if the floatation chamber is compromised for example by puncturing or penetrating it, or shooting at it. For example spray foam insulation such as the commercially available two-component mixture composed of isocyanate and polyol resin or Polyurethane, may be used.

In the depicted embodiment, sections 101x of the barrier are 12 to 150 m long, but longer or shorter section may be used. Section may be sized to fit standard transportation means such as the inside length of ocean container or comply with local regulations for commercial motor vehicles.

In the depicted embodiment, sections 101x of the barrier 100 terminate in a section connecting member 134 used for stability and linking the sections to form a long barrier. The section connecting members may provide mechanical connection between sections that is strong enough to withstand the forces of collision with floating bodies, wind waves and tide. Additionally, the section connecting members may provide connection of air hoses used for floating and submerging the barrier.

Optionally, in a dockside application the barrier 100 is only anchored to the dock 110 at both ends. Anchoring of barrier 100 to the dock 110 may be purely mechanical such as at dockside barrier anchor 141, or it may comprise interfacing with land facilities such as at dockside barrier interface 144. However, optionally, in a dockside application the barrier is also anchored to the sea floor or to other structures, for example to steady it against the current, and to prevent part of it to drift and be pushed against the ship. To avoid cluttering the figures, only few anchors 140 and anchor lines 142 are seen in this and other figures. The term “anchor” and “anchor line” should be viewed as non-limiting terms as sinker, anchors, ropes chains and other means used in the art for holding marine structures in place may be used. Number, types, locations and sizes of these anchors and anchor lines are determined according to the seafloor conditions, size, length and thickness of the barrier and anticipated forces on the barrier.

The barrier 100 optionally comprises a floating spill contamination skimming pipe (seen in more details in the following figures) to pump contaminated water. The skimming pipe is connected to a Contamination Treatment Facility (CTF) 150 via water pumping hose 151. CTF 150 may comprise a pump 152 for pumping contaminated water, a contamination separator 154 and contamination storage 156. Contamination separator 154 may comprise a centrifuge or a filter to separate liquid contaminants and solid contaminants from the water pumped by pump 152 and store the separated contaminants in contamination storage 156. After removing the contamination, purified water may be discarded or returned to the sea via a purified water discharge hose 159. CTF 150 facility may be situated on land or sea and connected to the barrier via the dockside barrier interface 144. Dockside barrier interface 144 connects the pneumatics 130 CTF 150 to the barrier 100 via hoses 132 and 151. Optionally hoses 132 and 151 are connected to Dockside barrier interface 144 with quick release connectors. The hoses may be equipped with check valves or any other suitable valve. Additionally, Dockside barrier interface 144 may connect electrical components such as sensors, actuators and other units (to be detailed in the following figures) to a command and control unit 170 via cable 172 or via wireless channels such as radio, microwave link, cellular link or satellite communications or other wireless communication. For example, sections of barrier 100 may comprise depth sensors to measure the depth of a submerged section. For example, actuators may be valves used for flooding a floatation chamber in order to submerge a section.

Additionally or alternatively, sections of the barrier may comprise a contamination pumping port 158 (or few such ports if the section is long) to allow connecting a Contamination pumping and Treatment Unit (CTU) 180. Such CTU may be installed on a barge 182 or a boat or any other floating device that may be piloted to the location where contamination is present. As the contamination is affected by wind and water current, skimming it may be more effective if applied to one or few of the barrier's sections 101x. The section connecting members 134 may comprise valves to control the activation of the contamination skimming action and/or the activation of the submerging/floating actions. These valves may be manually or remote controlled activated. Optionally a contamination pumping port 158 may be located on a section connecting member 134.

In some embodiments the barrier 100 system or some of its sections may be integrated with other mechanical recovery equipment such as: booms, skimmers, and sorbents that are commonly used to recover oil from the water surface.

In some embodiments the barrier 100 includes means to collect floating spill liquid contaminants spreading from within the protected zone 120. In some embodiments the barrier includes means to collect floating spill liquid contaminants spreading from outside the protected zone 121. In some embodiments the barrier includes means to collect floating spill liquid contaminants spreading within and outside the protected zone.

In some embodiments the barrier includes means to spread contamination treatment substance, for example, but not limited to chemicals capable of dissolving, neutralizing or solidifying specific contaminants or flame retarding materials and the likes. For example the same pumping hose 151 and skimming pipe used for collecting floating spill liquid may be used to spread contamination treatment substances stored in an optional contamination treatment substances storage 160. Alternatively separate hoses are used for spreading contamination treatment substances or oil dispersants or chemical agents such as surfactants, solvents.

The barrier 100 may optionally be equipped with external rapping fabric: polyester reinforced PVC (for example UV and hydrocarbons resistance strength PVC) that may further be used as a marking sign and as a disposable protective layer for system that may be discarded or cleaned after an oil spill.

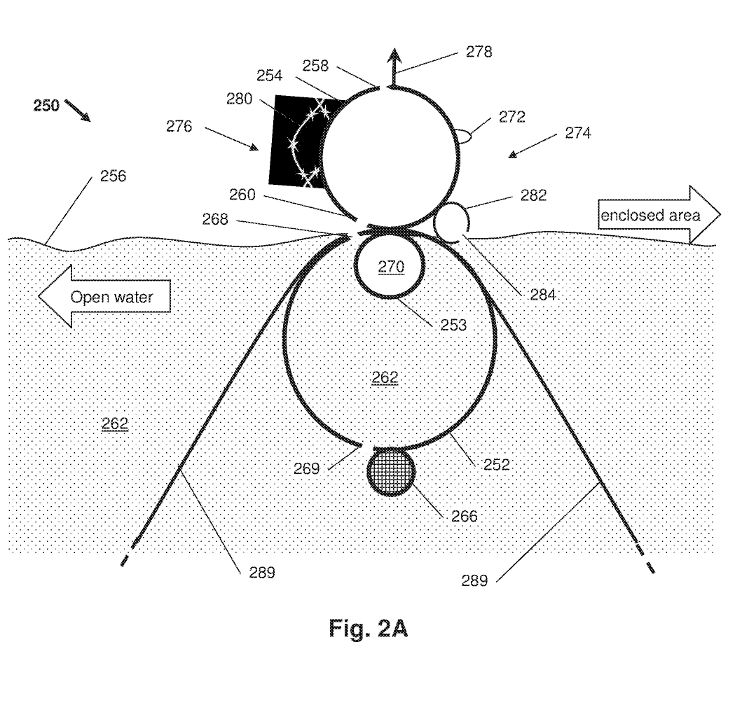

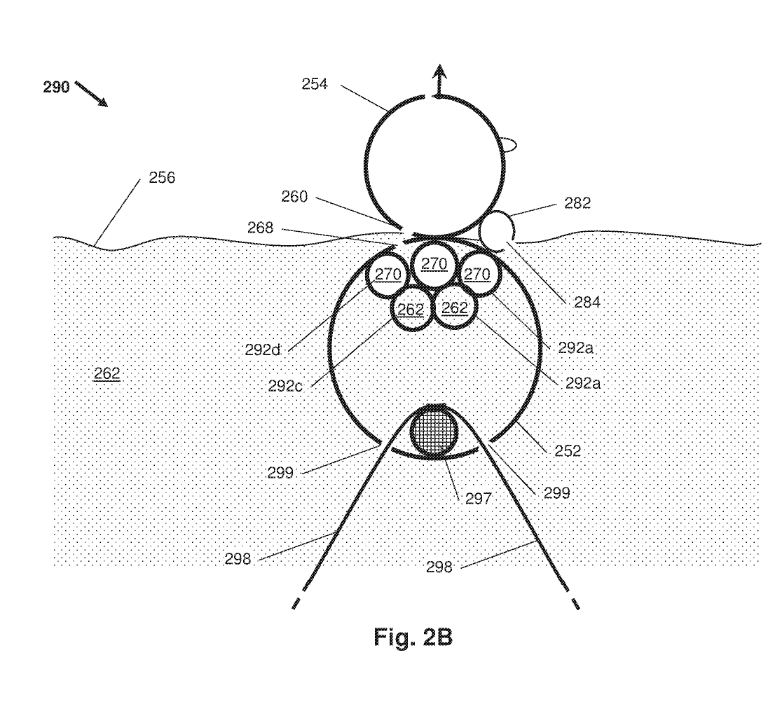

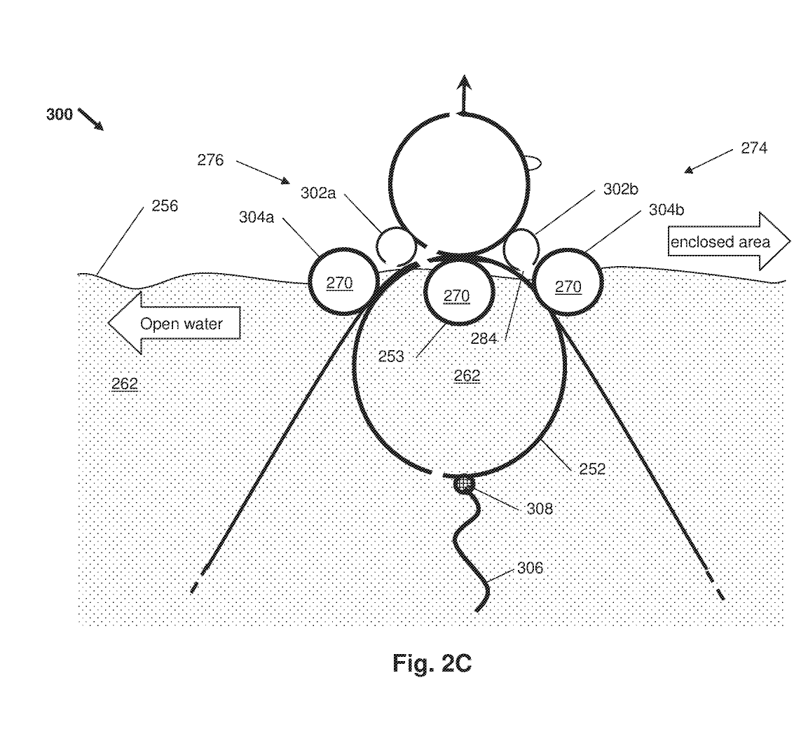

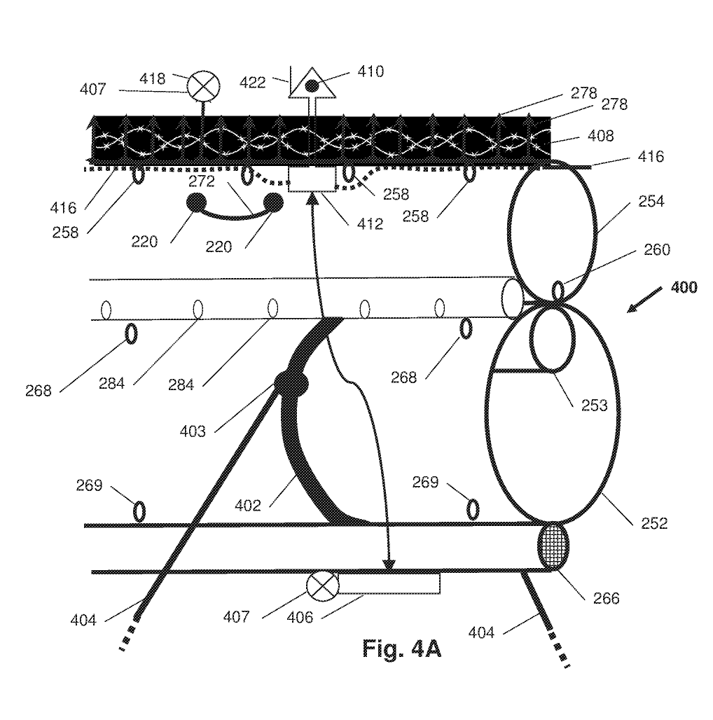

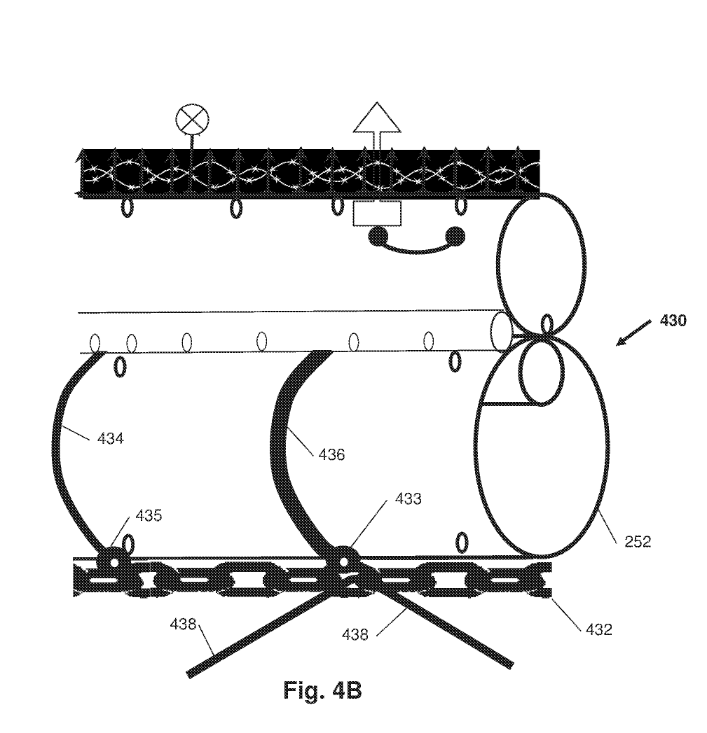

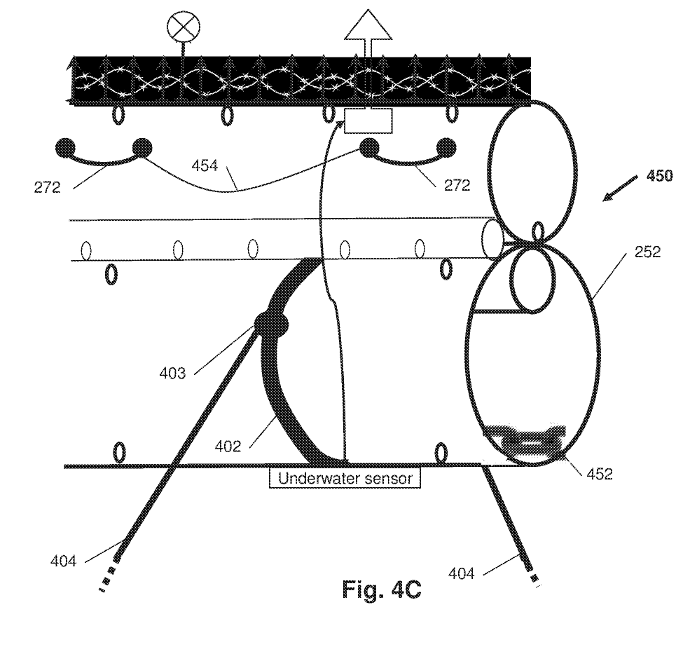

In this and the following figures the abbreviation “CTF” and “CTU” may be used for a Contamination Treatment Facility and unit respectively. Such CTF and CTU is connected to a contamination skimming pipeline (seen in FIGS. 2A, 2B and 4) and comprises a pump capable of performing at least one (or both of):
Pumping contaminated sea water from the contamination skimming pipe to a separator that separate the spilled contaminants from the ware. The separated spillage is then stored in spillage storage, while the clean water return to the sea.
Pumping contamination treatment substance or oil dispersants (chemical agents such as surfactants, solvents, and other compounds) from a storage into the contamination skimming pipe so it would be dispensed where needed.

It should be noted that optionally different pumps or different pipes and hoses may be used for the two purposes.

The CTF and CTU may be position on land, or on a boat or a barge or on any other floating device that can be maneuvered and attached to one of the contamination pumping ports along the barrier.

FIG. 1B schematically depicts a top view of a marine barrier 200 installed in open waters 221 according to an exemplary embodiment of the current invention.

In open waters application, the marine barrier 200 is generally constructed as a closed or semi close perimeter protecting the enclosed inner zone 220. The exemplary square shape of barrier 200 seen in this figure is for demonstration only and other polygon shaped zone may be constructed from straight sections 101x. Zones with an opening may also be constructed. Curved sections may also be used. The marine barrier 200 seen here is for demonstration only and other shapes may be used.

Open water application may be around a fixed facility such as an oil or gas rig, Floating Production Storage and Offloading vessels (FPSO), Conventional Buoy Mooring (CBM), Multi-Buoy Moorings (MBM), Single Point Mooring (SPM) or any other installation 212. Alternatively, the open water application may be installed at places where floating body devices are moored when waiting to enter a harbor. In the fixed application, the barrier may be floating most of the time and only parts of it submerge at times to allow access. In the second application, the entire barrier may be submerged to allow a floating body device to enter and exit the mooring place.

Anchoring of the barrier is done taking into consideration the local conditions such as length, safety distance, wind, currents, waves, tide, etc. The configuration seen here is for demonstration only and should not be viewed as limiting.

The pneumatic pumps and control system 130 that is used for floating and submerging the barrier or specific section of the barrier and may be placed on the fixed rig or floating body device 212. Alternatively, pneumatic pumps and control system 230 may be integrated within the barrier or with the barrier, or placed in a vessel, a buoy, a floating body device or a container near the barrier.

When pneumatic pumps and control system 230 is integrated in the barrier, it may be installed for example on a section 101d which stays afloat while causing section 101e to submerge forming a controlled entrance 122. The pneumatic pumps and control system 230 may optionally be submerged or fortified to protect it against unauthorized manipulation. The pneumatic pumps and control system may optionally be manually operated, remote controlled or automatically activated by sensors. Sensors may optionally be located on the barrier, on the protected asset, on shore or on buoys or combinations thereof.

Air hose 132 may be connected to barrier 200 at a pneumatics barrier interface 232, or at a section connecting member integrated with a pneumatics interface 238.

The floating and submerging control unit 130 may comprises air compressor and/or compressed air tanks or other gas tanks or other backup gas cylinders connected with air hoses 132 to the floatation chambers in the barrier.

Barge or floating body device 182 having a CTU may be within the protected zone 220 or in the open waters 221. Being inside the protected zone provides protection to Barge or floating body device 182. However, Barge or floating body device 182 may need to make frequent trips to deposit the separated contaminants on land or onto another vessel or floating body (not seen in this figure). Pumping hose 151 may be connected to barrier 200 in one of the pumping port 158, or at a section connecting member integrated with a pumping port 239.

FIG. 1C schematically depicts a top view of a marine barrier installed in open waters according to another exemplary embodiment of the current invention.

In this exemplary embodiment, barrier 240 is constructed of one or few long sections 241x that are generally semi flexible and are curved to form a circular or oval or any other shape protected zone 242.

Rigid and flexible sections may be used within the same barrier.

It should be noted that a long flexible section 241x may comprise a plurality of floating chambers. By flooding one or few flooding chambers, a part of a section may be submerged to form a controlled entrance 244.

In the depicted embodiment, pneumatics 230 comprises power supplies such as batteries, solar, panels, wind turbine, hydro turbine, wave energy harnessing device, or other green energy generator and optionally compressed air or gas tanks (or any other backup gas cylinders) and communicates with the marine platform 212 or command post on shore via wireless communication channel such as radio communication 246. Alternatively, pneumatics 230 is connected to the marine platform 212 or command post on shore via an underwater cable (not seen in this figure)

FIG. 1D schematically depicts a top view of two marine barriers 240 and 900 installed in open waters 221 creating an inner protected zone 242 and outer protected zone 902 according to another exemplary embodiment of the current invention.

Inner marine barrier 240 may be in the form seen in FIG. 1C, but other forms of inner barrier, for example barrier 200 seen in FIG. 1B may be used. The figure is not to scale and generally the size of outer barrier 900 is such that the distance from the asset or floating body 212 to be protected to outer barrier 900 is large enough that a hostile floating body or submersible body outside the outer barrier 900 is out of range for engaging the asset. For an oil or gas rig in deep waters, this range may be few hundreds meters or even over a 1,000 meters (1 kilometer and more), and thus the need for a barrier that may be economically constructed to provide protection over a perimeter of few kilometers.

Optionally, barriers 240 and 900 are constructed each with different characteristics. For example inner barrier 240 may provide human and/or spillage protection, while the outer barrier 900 provide protection against intruding floating bodies. Optionally, outer barrier 900 provides spillage protection as an additional safety measure.

For example, the inner 240 barrier may be placed at short range (for example few tens of meters) from an oil or gas rig or asset 212, aimed to stop intruders and light floating bodies (such as small vessels, rubber boats, jet ski, etc.) from entering, and to stop and collect floating spill liquid contaminants from spreading from the rig into the open sea. An outer barrier 900, may be aimed and constructed to detect, alert, stop (or at least delay) approaching floating bodies and may be placed further away from the asset 212. To perform this task, outer barrier 900 may not need contamination collection or treatment means. Moreover, outer barrier 900 may be optimized for stopping boats by being large, heavy and strong. Outer barrier 900 may be missing some or all the means to stop human intruders from climbing over it, while inner barrier 240 performs the task of stopping humans' intrusion or other types of sabotage.

In this exemplary embodiment, two pneumatic units 230 are installed on outer barrier 900. Due to the distance between rig 212 and outer barrier 900 it may be difficult to connect outer barrier 900 to a pneumatic unit 130 on rig 212. In this non-limiting example, controlled entrance 244 is seen in the section between the two pneumatics barrier interfaces 232. To avoid cluttering this figure, anchoring means were not drawn.

Large perimeter protection such as provided by barrier 900 may provide pollution protection in catastrophic events such as undersea oil leak and/or fire, explosion or complete collapse of the asset 212 such as experienced at the Deepwater Horizon oil disaster at the Gulf of Mexico in April 2010. In that event, any barrier nearby the Deepwater Horizon oil rig may not have survived is explosion, fire and collapse. Additionally, in this case the oil, leaking from depth of 1,600 meter below sea level and already considerably dispersed when arrived to the surface.

FIG. 2A schematically depicts a side cross sectional view of a marine barrier 250 in floating state according to an exemplary embodiment of the current invention.

An exemplary construction and exemplary operation of the barrier 250 is demonstrated in this figure.

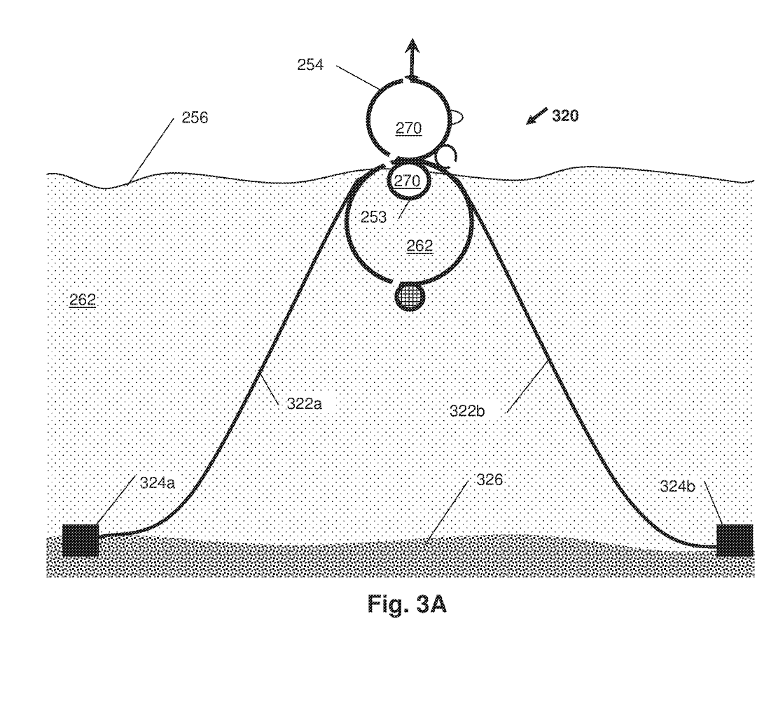

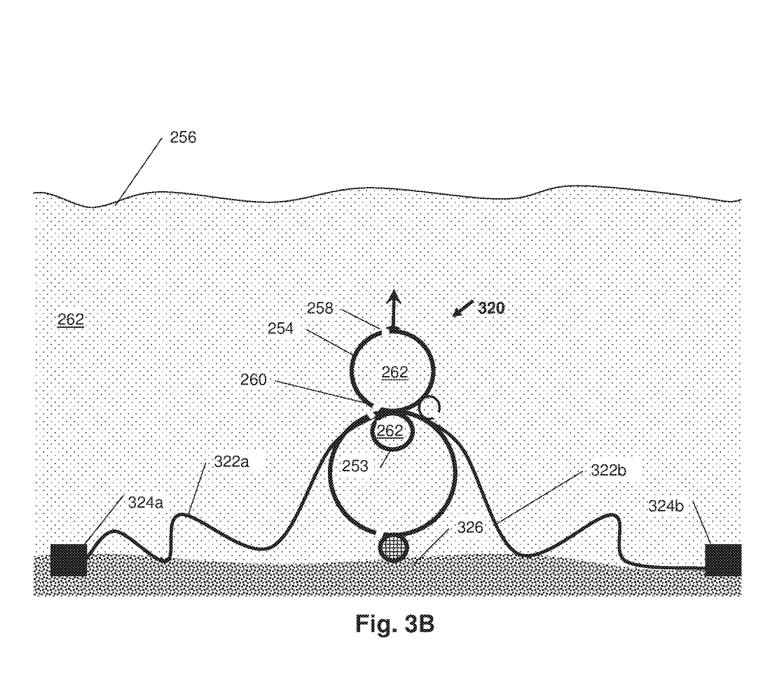

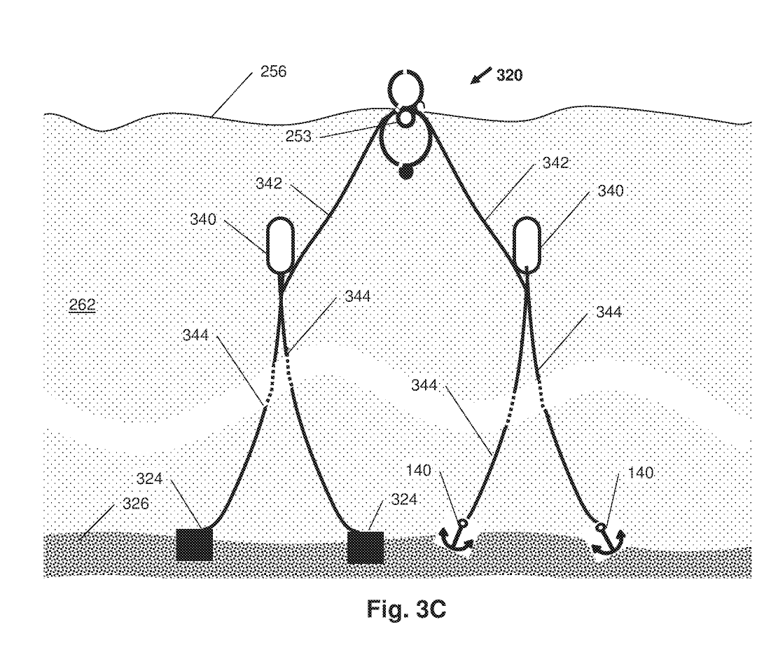

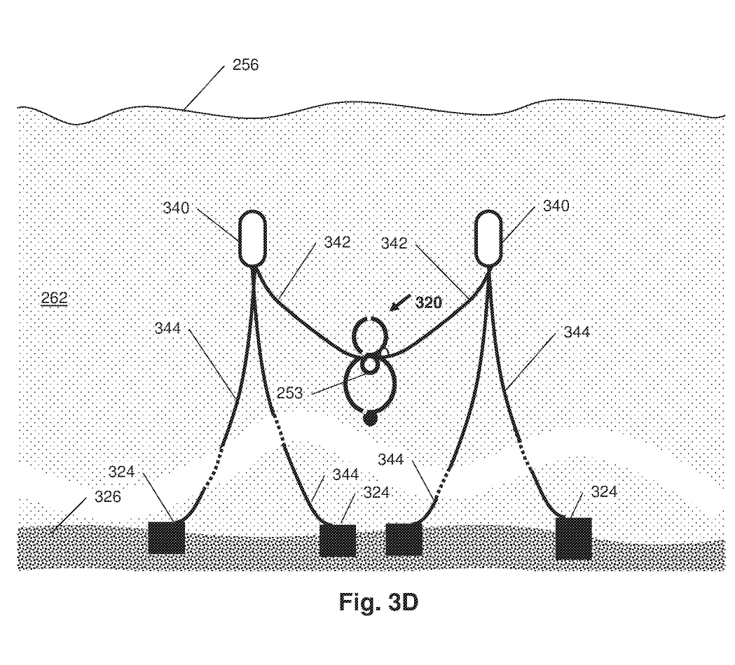

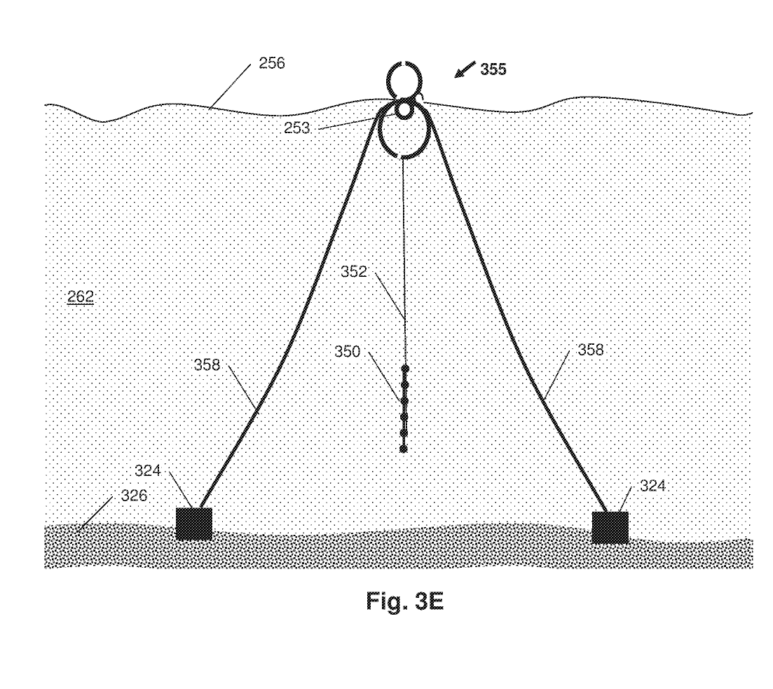

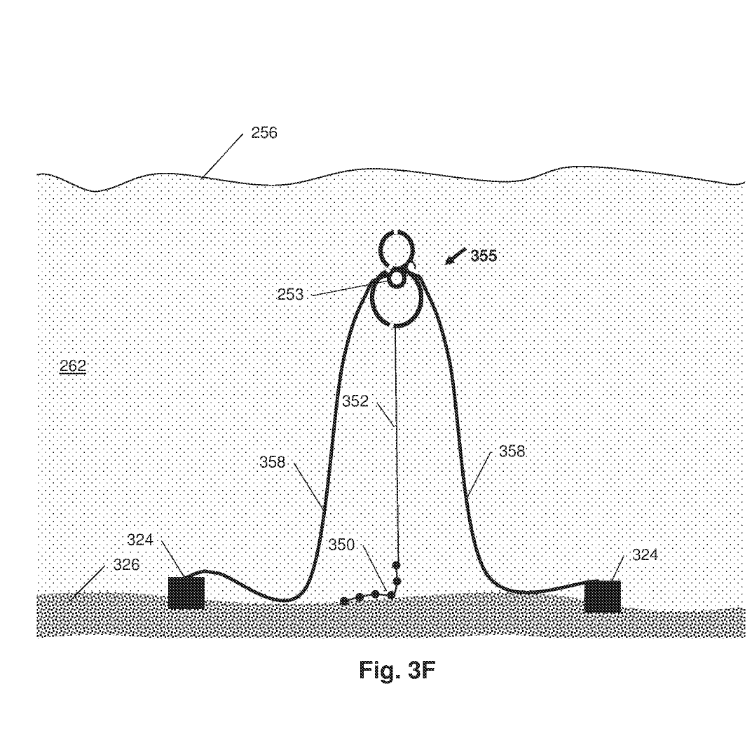

The barrier 250 comprises a main body 252 which stays substantially submerged and provides a stable base for the barrier body 254 which in the floating state protrudes above the water level 256 and creates a barrier against people, vessels and floating spill. The barrier body 254 comprises a pipe having air vent openings 258 at its upper part and water drain openings 260 at its lower part, allowing it to be drained of water when in floating state and be flooded with water when in submerged state (seen in FIGS. 3A to 3F),

The main body 252 comprises a pipe that is substantially full (or partially full) of water 262 in both submerged and floating states, thus providing large mass and resistance against pushing barrier 250 about.

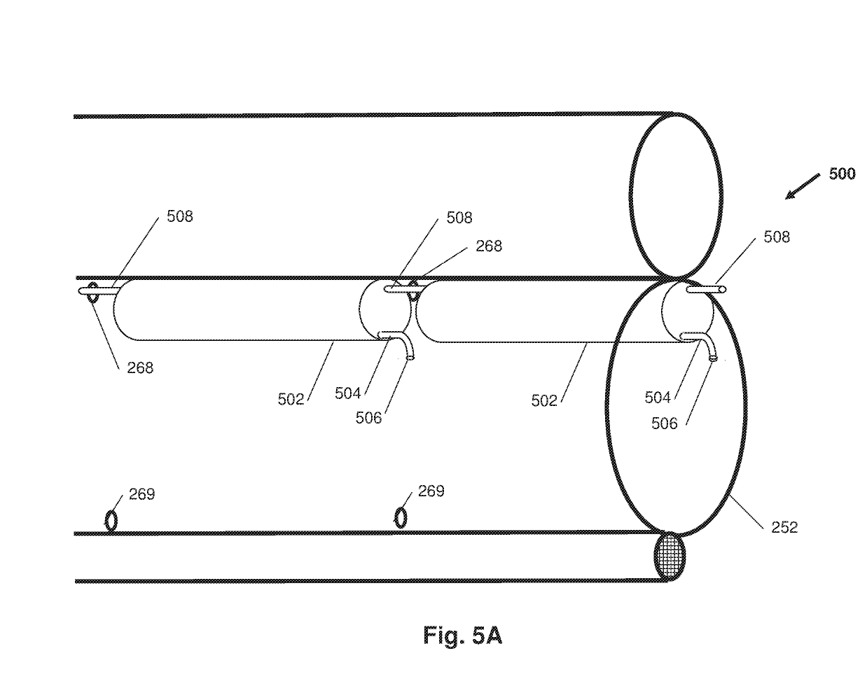

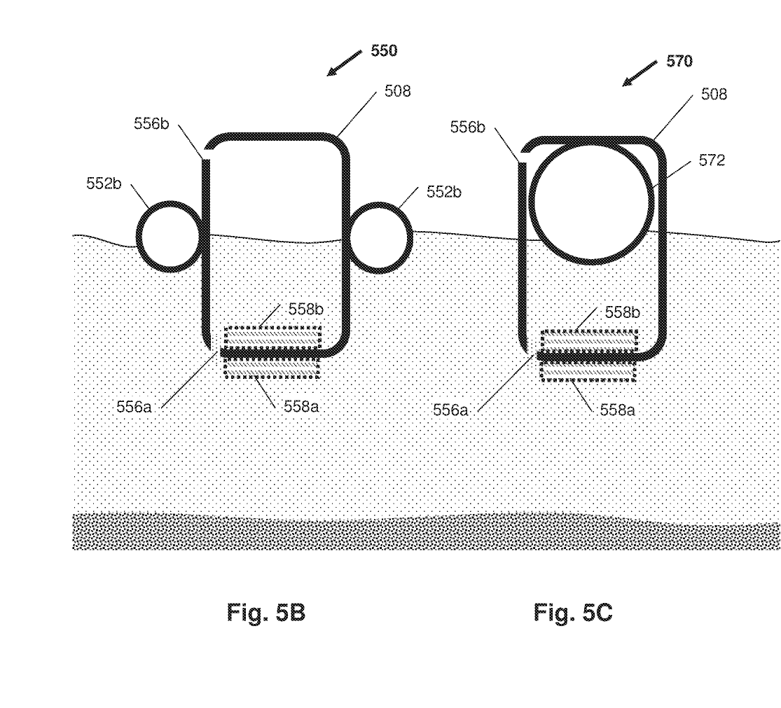

Internal or external to the main body 252 and near its upper part is a floating chamber 253 (or a plurality of chambers, as seen in FIGS. 2B and 5). Weight 266 may be located at the bottom of the main body causes the barrier to be bottom heavy and stay upright. The weight 266 may be external to the main body (as seen in these figures) or to be internal to the main body at its lower end or weights may be placed both internally and externally to the main body. Weight may be made of metal such as lead or iron. Alternatively it may be made of cast or blocks of concrete. Optionally, the weight comprises a pipe filled with heavy particles such as sand or stone, or comprises a plurality of solid sections such that the barrier maintains its semi-flexible properties. Optionally the weight is in a form of a heavy chain or steel cable. A chain may provide both weight and tensile strength, while retain flexibility. Such a cable or chain 297 may be inserted into the main body 254 and rest on its bottom due to its weight, or attached to the bottom of main body 252 in several places as will be seen in FIG. 2B.

In a floating state, the floating chamber 253 is filled with gas such as air 270 to cause the barrier 250 to float such that the top of the main body 252 is near the water surface 256. To sink the barrier, the floating chamber 253 is filled with water.

Optional openings 268 and 269 in the main body 252 allow water to enter and exit the lumen of the main body 252 to account for expansion of the water due to changes in temperature or when the floating chamber 253 expand and contract due to the changing of air or water pressure in it. Specifically, when the floating chambers are constructed to vent excess of air in order to avoid over inflation, the excess air may escape the main body 252 via the optional opening 268 (as seen in FIG. 5). Similarly, if air is let out of the floating chamber 253 into the lumen of the main body 252 while the floating chambers are to be flooded, water may enter into the main body via the lower optional openings 269, and air may exit via optional openings 268. Additionally, the optional openings are useful for draining the main body 252 should the barrier 250 is to be removed from the water.

Optionally the barrier body comprises holding handles 272 and/or life line to assist maintenance personal in climbing and holding onto the barrier while inspecting or servicing it. Optionally the holding handles are used for tying vessels used for maintenance. Preferably the holding handles are located on the side 274 of the barrier facing the inner protected zone and are absent on the opposite side 276 of the barrier facing the open water. However, holding handles 272 may be located on both side of the barrier.

Optionally, anti-climbing or anti-penetrating means 278 such as sharp pointed spikes and/or barbed wire or other kind of obstacles are installed on top of the barrier body 254 to prevent or at least delay passage of people, machinery and/or equipment over the top of the barrier. Optionally, additionally or alternatively, anti-climbing means 280 such as sharp pointed spikes and/or barbed wire are installed on side 276 of the barrier facing the open water of the barrier body 254 to prevent or at least delay passage of over the top of the barrier. Optionally anti-climbing and/or anti-intruder and/or penetrating means 280 are installed on both sides. Additionally and optionally, armor such as metal plate, Kevlar material or ceramic bulletproof material or combination thereof is installed on the outside or on both sides of the barrier to protect it against attempt to puncture the floatation chamber(s) and causing the barrier to sink.

To skim floating contaminants, the barrier 250 may comprise a contamination skimming pipe 282 having a plurality of contamination skimming opening 284. Depending on the anticipated source of contamination the contamination skimming pipe may be on the side 274 facing the inner of the protected zone (as seen in this figure) or the side 276 facing the outside of the protected (not seen in this figure). Optionally contamination skimming pipes or other skimming machinery or skimming equipment are placed on both sides of the barrier.

Preferably, the weight of the weight 266 and the displacement of the floatation chamber 253 are such that the contamination skimming pipes 282 are at or near the water surface 256 when the barrier is in floating state. Optionally, height of the contamination skimming pipe may be adjusted such that the contamination skimming opening are at the correct level by adjusting the amount of air 270 in the floatation chambers 253 (by partially flooding floatation chambers 253).

Optionally, contamination skimming pipes skimming machinery or skimming equipment may be an add-on module that may be install inside or outside the perimeter or only in designated areas.

In the depicted embodiment, some pipes that the barrier is made of (252, 253, 254, and/or 282) are extruded pipes that are welded together, or heat welded or connected together using rivets or other fatteners such as connectors or flanges or other action that result in connecting the floating bodies. It should be noted that the term “pipe” herein refer to elongated conduit not necessarily having a circular cross-section.

The barrier seen here is anchored using anchoring lines 289. Anchoring lines 289 are preferably connected to the barrier using a clamp or clamps (not seen in this figure). Optionally, belts, bands, brackets or pipe hangers are used for connecting the anchoring lines 289 to the barrier 250. Optionally, the anchoring lines are connected to the chain that is used a weight 266 (as seen in FIG. 2B). In the embodiment depicted here, anchoring lines 289 are looped over the main body 252 of the barrier 250. The anchoring lines 289 are inserted in gaps between the main body 252 and the body 254 of barrier 250. Alternatively, anchoring lines 289 are inserted in optional openings in body 254 of barrier 250. These optional openings may be used as water drain openings 260.

Alternatively, anchoring lines 289 are connected to the barrier using a clamp or clamps, belts, bands, pipe brackets, pipe hangers, saddles system and the likes.

Optionally anchoring lines 289 are flexible or incorporate flexible or stretchable parts or units to absorb and dissipate wave energy thus prevention the braking of the line, dislodging the anchors or damage to the barrier at the barrier-line connections.

As a non-limiting example, the pipes used in constructing the barrier body 254 and main body 252 (and optionally other structures such as the floatation chambers) are made of HDPE, PEX, PV, or other similar thermoplastic materials. As a non-limiting example, the diameters of the pipes used in constructing the barrier body 254 and main body 252 or the floatation chamber 253 are between 25 mm and 3,000 mm Smaller size barrier may be used for spill protection only. Larger diameter pipes may be used when the barrier is designed to withstand ramming by a vessel such as a speedboat, using floating explosive devices, etc.

Plastic pipes may be commercially available at lengths up to 3,500 m, thus long stretch of barrier may be constructed using such pipes.

FIG. 2B schematically depicts a side cross sectional view of a marine barrier 290 having multiple floatation chambers in floating state according to another exemplary embodiment of the current invention.

This exemplary embodiment differs from the embodiment seen in FIG. 2A in that a plurality of floatation chambers 292x are used. By filling some of the flotation chambers with air the flotation level of the barrier may be adjusted, for example to bring the contamination skimming openings 284 in skimming pipe 282 to the desired level, for example at or slightly below the water level 256, optionally, some of the floatation chambers may be filled with foam, small floatation structures such as babbles and the likes. Additionally, floatation may be maintained even is some of the floatation chambers 292x are flooded due to malfunction or if punctured by a hostile intruder. In the example depicted in this figure, two (292a and 292c) of the five floatation chambers 292x are flooded. The use of multiple floatation chambers creates redundancy, and flexibility in the operation of the barrier. Larger or smaller number of floatation chambers 292x may be used. Some floatation chambers 292x may be partially flooded. Some floatation chambers 292x may be partially in floatation state if are partially filled with foam.

This exemplary embodiment also differs from the embodiment seen in FIG. 2A in that anchoring lines 298 are looped around the weight 297. In the depicted embodiment, anchoring lines 298 exit the main body 252 via optional openings 299 that may also serve the same function as the optional openings 269 seen in FIG. 2A.

FIG. 2C schematically depicts a side cross sectional view of a marine barrier 300 having contamination skimming pipes 302a and 302b, and stabilizing floatation chambers 304a and 304b on both sides and further comprising divers net or other barrier 306 and chain 308 as a weight according to another exemplary embodiment of the current invention.

The exemplary embodiment depicted in this figure optionally comprises two contamination skimming pipes 302a and 302b such that spillage may be collected from the side 274 facing the inside the protected zone or from the side 276 facing the outside the protected zone, or from both sides.

The exemplary embodiment depicted in this figure further comprises stabilizing floatation chambers 304a and 304b on both sides of the main of the main body 252. Optionally the stabilizing floatation chambers 304x are connected to the pneumatic floating control unit and may be filled with air 270 to provide additional buoyancy to barrier 300. Optionally the stabilizing floatation chambers 304x are flexible inflatable sacks. Optionally the stabilizing floatation chambers are flexible or rigid chambers filled with air (or any other gas) or with solid foam.

It should be noted, that in this and other embodiments of the invention, the number of floating chambers that are full of air, and the amount of air in these floating chambers may be adjusted according to need. For example, as sea fouling accumulates on the barrier making it heavier, air may be added to the floating chambers to keep the level of floatation. Additionally, if a suspicious boat or other floating body is approaching, the barrier may be made to float higher in the water to prevent passage of the boat. Additionally, if the spillage skimming action is to be activated, the floatation of the barrier may be adjusted such that the contamination skimming openings 284 are at or just below the water level.

Optionally the marine barrier seen here and in other embodiments further comprises a diver's net 306 to prevent or delay divers or swimmers from entering or exiting the protected zone by diving under the barrier 300. The diver's net 306 may be connected to the sea floor or extend to depth below the depth that a diver can easily reach. The diver's net may provide some of the weighting and the stabilizing effect of the weight. Thus, the weight 308 may be smaller or missing altogether. Optionally the diver's net may include sensors (not seen in this figure) for sensing passage of a diver, underwater intruder or submerge equipment, or if the net was damaged, removed or penetrated.

FIG. 3A schematically depicts a side cross sectional view of a marine barrier 320 installed in shallow water, in floating state, according to an exemplary embodiment of the current invention.

Marine barrier 320 may be any of the barrier disclose in this document. When the marine barrier 320 is installed in shallow waters it may be anchored by connecting the barrier at least some points using two anchoring lines 322a and 322b which are spread substantially normal to the length of the barrier 320 to restrain its movement in both directions. Such construction is seen in FIG. 1C and FIGS. 2A-C. It should be noted that in FIG. 1C only 4 pairs of anchoring lines are seen, but number of pairs may be considerably larger. Anchoring lines 322x may have some slack in order to allow for motion cased by waves and tide without yanking the seabed anchoring 324x or to cause breaking of the anchoring lines. Seabed anchoring 324a and 324b may be a heavy weight (sinkers, mooring means such as anchors, weights and/or any marine infrastructure that can be mounted on sea bed, etc. as seen in this figure), an anchor or a post driven into the seabed 326, or other anchoring unit known in the art.

FIG. 3B schematically depicts a side cross sectional view of a marine barrier 320 installed in shallow water, in submerged state according to an exemplary embodiment of the current invention.

As was explained before, when flooding the floatation chamber 253 or 304x with water 262, the entire barrier 230 sinks and rests on the sea floor 326. Note that the body 254 of barrier 320 is also flooded with water 262 as explained in regard to the air vent openings 258 and the water drain openings 260 in the text related to FIG. 2A.

FIG. 3C schematically depicts a side cross sectional view of a marine barrier 320 installed in deep offshore waters, in floating state according to an exemplary embodiment of the current invention.

When the marine barrier is installed in deep waters, for example around an oil rig where depth may be hundreds or even thousands of meters, direct anchoring of the barrier to the sea floor may poses few problems: The long lines may get entangled when the barrier is submerged; the barrier may drift while submerged due to deep-sea currents and collide with the marine assets it is protection (e.g. the legs of the oil rig), the lines may get entangled with underwater debris or rocks, and devices such as sensors and controls attached to the barrier may crush under the immense water pressure.

To overcome these problems, an indirect anchoring may be used. Intermediate buoys 340 are anchored to the seafloor 326. These stationary intermediate floats 340 are used as anchoring reference points for the barrier's anchoring lines 342.

Note that the figure is not to scale as the depth of the intermediate buoys 340 is generally just below the depth needed to avoid damage by passing vessels, currents and/or foul weather. Intermediate buoys 340 are anchored to the seafloor 326 as known in the art, for example using sinkers 234 or anchors 140, and buoys anchoring lines 344.

In floating state depicted in this figure, floating chamber 253 or 304 is full of air. The floats have enough buoyancy to support the barrier in its submerged state as will be seen in FIG. 3D.

The embodiments depicted in FIGS. 3c and 3d may be suitable for use in deep water, for example in depth of over 100 m, and up to very deep water of thousands of meters.

FIG. 3D schematically depicts a side cross sectional view of a marine barrier 320 installed in deep water, in submerged state according to an exemplary embodiment of the current invention.

When the flotation chamber 253 or 304x is flooded, the marine barrier 320 sinks and stay supported above seafloor 326 by the intermediate buoys 340 via the intermediate anchoring lines 342.

FIG. 3E schematically depicts a side cross sectional view of a marine barrier 355 installed in deep water, in floating state according to yet another exemplary embodiment of the current invention.

Like the embodiment of FIGS. 3C and 3D, in the embodiment depicted in FIGS. 3E and 3F barrier 355 do not sink all the way to the sea floor 326 when submerged. A depth limiting weight 350 (or a plurality of such weights) is connected to the bottom of the barrier 355 at the end of a submerging line 352.

Optionally, the depth limiting weight 350 is a heavy metal chain, or a plurality of weights strung on a rope, cable or a chain and a like. The advantage of such distributed weight is that if the distributed weight rests on a muddy or sandy bottom, and gets covered or buried, it can be freed by the floatation force, optionally combined with the tugging force of the waves. In contrast, a single massive weight, if stuck in mud or covered by drifting sand it may not be easy to dislodge.

Once the depth limiting weight 350 rests on the sea floor, the marine barrier 355 stops sinking since it designed to be lighter than water even with its floatation chamber 253 or 304 flooded. To achieve positive buoyancy for the barrier 355 (excluding the depth limiting weight), the normal weight at the bottom of the barrier (266, 297, or 308 seen in pervious figures) may be small or missing. In this case, the depth limiting weight 350 keeps the barrier upright. An optional permanent (that is not to be flooded) float may be installed in the barrier main body (not seen in this figure) to provide positive buoyancy to the barrier 355 when the floatation chamber 253 are fully flooded to prevent the barrier from sinking to the bottom of the sea.

Optionally, a diver's net may be used as submerging line 352.

FIG. 3F schematically depicts a side cross sectional view of a marine barrier 355 installed in deep water, in submerged state according to yet another exemplary embodiment of the current invention.

In this figure, the depth limiting weight 350 is at least partially resting on the seafloor 326 and slack is seen in the long barrier anchoring lines 358.

FIG. 4A schematically depicts an isometric view of a section of marine barrier 400 showing some details of its construction according to an exemplary embodiment of the current invention.

This figure shows some details of the marine barrier 400 which is similar to barriers 100, 200, 240, 250, 290, 300, 355, 320, 900, 550, 570 seen in this document. As most of the elements seen in this figure were already discussed in the text related to previous figures they will not be repeated here. The optional new elements that will be mentioned here are:

Optional clamp 402 that may be used for connecting the anchoring line 404 to the barrier 400. Clamp 402 seen here is in a form of a band attached around the main body 252 of barrier 400 and spreads the forces exerted by anchoring line 404 on large area, this clamp can be placed on the main body 252, body 254 or both. In addition the clamp may be attached with a bridge with the nearest clamp in order to reduce tension from the body. This prevents anchoring line 404 from rubbing against the softer material of main body 252 causing damage to the body. Band may be made of material with water durability and strength (e.g. metal) and preferably is tightened around the body. Anchoring line 404 may loop over the main body 252. Optionally, additionally or alternatively, anchoring line 404 may be attached to clamp 402 at clamp-line attachment 403. Clamp 402 may be used in addition to the anchoring line 404 looping over the main body 252, body 254 or both.

Barbed wire 408 is seen in this figure stretched between spiked fences 278 to deter crossing over the barrier. The fence may optionally be a folding fence (horizontal or vertical folding), the folding fence may be attach with a cable, wire or rope to a weight system that (not seen in this figure) ensures that the fence will be substantially erect when the system in flotation mode.

Above water sensors 410 such as a radar or optical sensors (visible, IR or thermal cameras, or other sensor known in the filed today) may be positioned on the body 254 and/or body 252 of barrier 400. Cameras and other sensors 410 may be concealed, or placed on a pole for longer range of view. Above water sensors 410 may comprise intrusion detectors such as detector capable of detecting handling or cutting barbed wire 408.

Electronics box 412, which may be attached to the barrier 400, or may be placed within the barrier.

Optional underwater sensor 406 may comprise sensors such as sonar may be attached to the main body 252 or barrier 400 below the waterline. Such sensor may be used for detection of divers attempting to pass below the barrier. If diver's net (not seen in this figure) is used, underwater sensor 406 may comprise sensor capable of detecting handling or cutting the net.

Anti diver net in the form of fiber optic fence, skirt, curtain, or metallic net with non-explosive and non-energetic reactive armor and under water sensors may be connected to the barrier (not seen in this figure).

Light system or light equipment 407, may be attached to the main body 252 or barrier 400 below the waterline and/or the above the water line.

Electronics box 412 may be placed within the barrier's body 254 for concealment and protection. Alternatively, Electronics box 412 may be attached outside the barrier's body or within the main body 252. Electronics box 412 serves the sensors and light system or any other equipment that consume energy 410, 406 and 407 and may be fitted with a communication antenna(s) 422 for wireless communication with a command and control center (not seen in this figure).

In some embodiments electronic box 412 comprises batteries for independent power supplying or as backup power supplying. The batteries may be replaceable or rechargeable. Optionally, solar panels or hydro power harnessing wave or currents power (not seen here) are used for charging the batteries. Additionally, or alternatively, electronic box 412 may be connected by an electric cable 416 to a command and control center for power supplying and data exchange. Cable 416 may optionally be concealed within the body 254 or the main body 252 or both.

Warning and collision avoidance devices 418 such as beacons, lights, horns, signs, light reflectors and radar reflectors may be posted on top of the body 254 or the main body 252 or both. Active warning devices such as beacons, lights, audio device, energy pulse device and horns may be powered and controlled from the electronic box 412.

It should be noted the alarming and collision avoidance devices 418, electronic box 412, and sensors 410 and 406 are places in multiple locations along the barrier for full coverage of the protected zone.

Holding handle 272 is seen here in some more exemplary details, attached at both ends 220 to the body 252 of barrier 400. Preferably, such handles 272 are attached to the barrier at locations near serviceable elements such as the above water sensors 410, electronics box 412, light system 407 and warning devices 418.

FIG. 4B schematically depicts an isometric view of a section of marine barrier 430 using a chain 432 as a weight according to another exemplary embodiment of the current invention.

Optionally a heavy chain 432, for example made of iron or steel is used as a weight. A chain provides not only weight but also tensile strength. This adds to the ability of the barrier to withstand the forces of nature and to resist to braking through the barrier by force, for example by trying to ram it with a boat.

Additionally, chains maintain the flexibility of the barrier 430 and are commercially available at various length, weights, strengths, and sizes.

In this exemplary embodiment, the chain 432 is connected to the barrier 430 by a plurality of clamps or belts 434 and 436. However, other method of connecting a chain to the barrier may be used. Optionally, the anchoring lines are connected to the chain. Optionally, claps 436 are used for connecting both chain 432 and anchoring lines 438 to the main body 252 or other parts of barrier 430 at clamp-chain-line connector 433, while claps 436 are used for connecting chain 432 to the main body 252 at clamp-chain connector 435. Optionally claps 436 are stronger, and preferably wider than claps 436.

FIG. 4C schematically depicts an isometric view of a section of marine barrier 450 using a chain 452 internal to the main body 252 as a weight according to yet another exemplary embodiment of the current invention.

In this exemplary embodiment, the chain 452 is internal to the main body of the barrier. Chain 452 may be connected to the bottom of the body 252 of barrier 450 at intervals along its length.

Lifeline 454 is seen connected between adjacent holding handles 272.

Optionally, the weight such as chain or cable 432/452 may be weaved in and out to main chamber 252. Optionally, anchoring lines 438 would then be connected to the chain at locations where the chain is external to the chamber 252. This option reduces complexity as it may not use clamps 432, 436 and 202. Additionally, the chain is connected to the main body in multiple places (at the places where the chain crosses the main body skin.

FIG. 5A schematically shows an isometric depiction a floatation chambers 502 having air venting tubes 504 of a barrier 500 according to an exemplary embodiment of the current invention.

In this exemplary embodiment, the floatation chambers 502, seen here within the main body 252 of the barrier 500, are constructed as rigid or semi-rigid chambers with vent pipes 504 extending from the bottom of the each floatation chamber 502. Each vent pipe 504 is having an opening 506 well below the bottom of the flotation chamber 502. Vent pipe 504 need not be curved as seen here. The figure is not necessarily to scale. Vent pipes 504 may be longer or shorter than seen in this figure and may be ended external or internal the barrier 500. A wider or narrower hose nozzle than seen here in this figure may be used. Vent pipe 504, may be connect to valves (e.g. check valve, not seen in this figure).

Air hoses 508 connect the plurality of floatation chambers 502 to each other and to the pneumatics 130 (not seen in this figure). When air is pumped through the air hose 508, the air forces the water in the flotation chambers 502 out of the opening 506 of vent pipe 504 until sufficient amount, most or all the water is out of the floatation chambers 502. The expelled water exits the main body 252 via optional openings 268 at the top of main body 252. At that stage some air may exit the vent pipe and this can serve as a visible signal that the flotation chambers are empty of water.

To re-flood the flotation chamber(s), the air hose is vented to the atmosphere. Water then enter trough the openings 506 of vent pipes 504 which are opened to the water and flood the flotation chambers. Water enters the main body 252 via optional openings 269 (and/or 268) at or near the bottom of the main body and in parallel, water enters the body 254 via optional openings 258 (not seen in this figure), thus re-flood the barrier 500.

This arrangement allows using rigid or semi rigid floatation chambers 502, for example made of plastic tubes the kinds use for irrigation and water supply without the need to accurately control the amount of air inserted or released from the floatation chambers and without the risk of over inflation or collapse of the floatation chambers. Using rigid or semi rigid floatation chambers 502 may be superior to using inflatable flexible sacks as flotation chamber for price, reliability and/or longevity considerations. Floating and submerging the barrier 500 is rapid since only air has to travel the entire length of the air hoses, while the more viscose water can enter and exit the floatation chambers at multiple locations via the vent pipes.

Optionally, a long pipe is used as both air hose and floatation chamber. Such long pipe preferably fitted with multiple vent pipes connected and opened to its underside at regular intervals.

Optionally, floatation chambers 502 can be install externally to the main body 252 and be located to side of barrier 500.

Floatation chambers 502, may be operated to control height of the barrier above the water level.

FIG. 5B schematically depicts cross section of a marine barrier 550 having an integrated body 508 and external floatation chambers 552x according to an exemplary embodiment of the current invention.

In this exemplary embodiment, an integrated body 508 assumes the functions of both body and main body of the barrier.

An optional weight 558x (herein, weight 558b is seen internal to integrated body 508, and weight 558a is seen external to integrated body 508) keeps the barrier upright. Optionally, external and internal weights are used. Optionally yet, no weights are used and the barrier remain upright due to the weight of the integrated body.

Two external floatation chambers 552a and 522b are seen connected to both sides of the integrated body 508. Water and air may enter and exit the integrated body 508 via openings 556a and 556b.

To reduce cluttering in the figures, structures such as anchoring lines, sensors, and other structures seen in pervious figures were omitted.

FIG. 5C schematically depicts cross section of a marine barrier 570 having an integrated body 508 and internal floatation chamber 572 according to an exemplary embodiment of the current invention.

In this exemplary embodiment, an integrated body 508 assumes the functions of both body and main body of the barrier.

An optional weight 558x (herein, weight 558b is seen internal to integrated body 508, and weight 558a is seen external to integrated body 508) keeps the barrier upright. Optionally, external and internal weights are used. Optionally yet, no weights are used and the barrier remain upright due to the weight of the integrated body.

A single internal floatation chamber 572 is seen within the integrated body 508. However, a plurality of internal floatation chambers may be used, or a combination of internal and external floatation chambers may be used. Water and air may enter and exit the integrated body 508 via openings 556a and 556b.

To reduce cluttering in the figures, structures such as anchoring lines, sensors, and other structures seen in pervious figures were omitted.

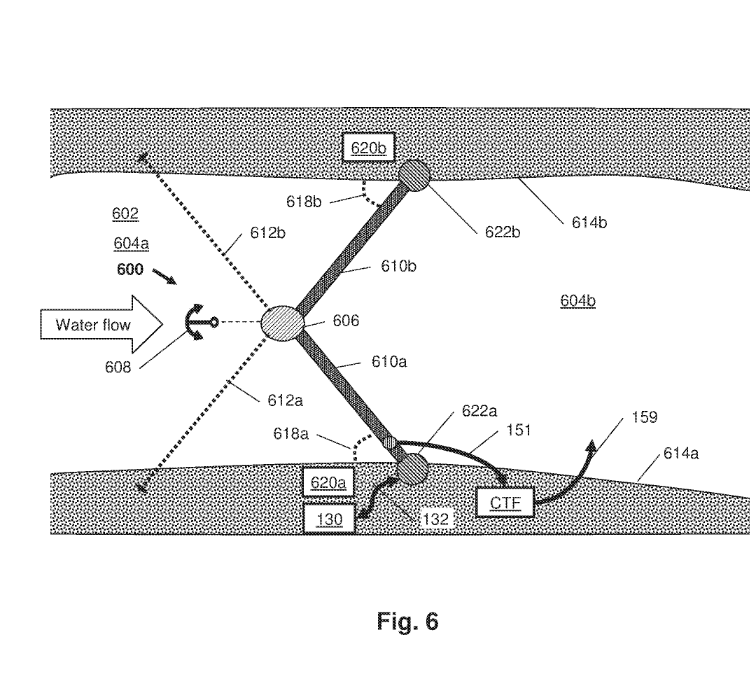

FIG. 6 schematically depicts a top view of a marine barrier 600 installed in a river, canal, channel, narrow port entrance, ditch, trench etc, 602 according to an exemplary embodiment of the current invention.

To protect a zone 604x within a river or a channel with flowing water, a barrier 600 may be anchored to the two river banks 614a and 614b or only to one of the banks. The protected zone may be upstream (604a) or downstream (604b) from the barrier 600. To create an enclosed protection zone, an upstream and a downstream barrier are needed. However, as floating debris moves with the current the pollution protection depends on the water current (which may change due to tides).

An optional central buoy(s) 606 is anchored, for example by anchor(s) 608, upstream near the center of the river to hold the two sections 610a and 610b of the barrier in place. Optionally, anchor(s) 608 is replaced or augmented by lines 612a and 612b anchored to the river banks 614a and 614b respectively. Alternatively yet, central buoy may be missing. Sections 610a and 610b of barrier 600 are anchored to the river banks 614a and 614b at barrier anchors 622a and 622b respectively

An optional pneumatic control unit 130 may be used for submerging the entire or parts of the barrier 600 to allow passage of boats or any floating body.

Drifting debris or floating liquid may collect between the barrier sections 610a and 610b and the river banks 614a and 614b at the floating debris/floating liquid accumulation zones 618a and 618b respectively. Optionally a solid debris/floating liquid collection facility 620a and 620b are used for removing and disposing the accumulation debris/floating liquid. Such solid debris/floating liquid maybe gather and remove to collector facility, contamination separation facility may comprise conveyer belts or scooping devices or pumping devices.

Additionally, a CTF may be located near barrier 600 (for example on one or both side of the river banks), and connected to the barrier 600 to collect floating liquid pollutants.

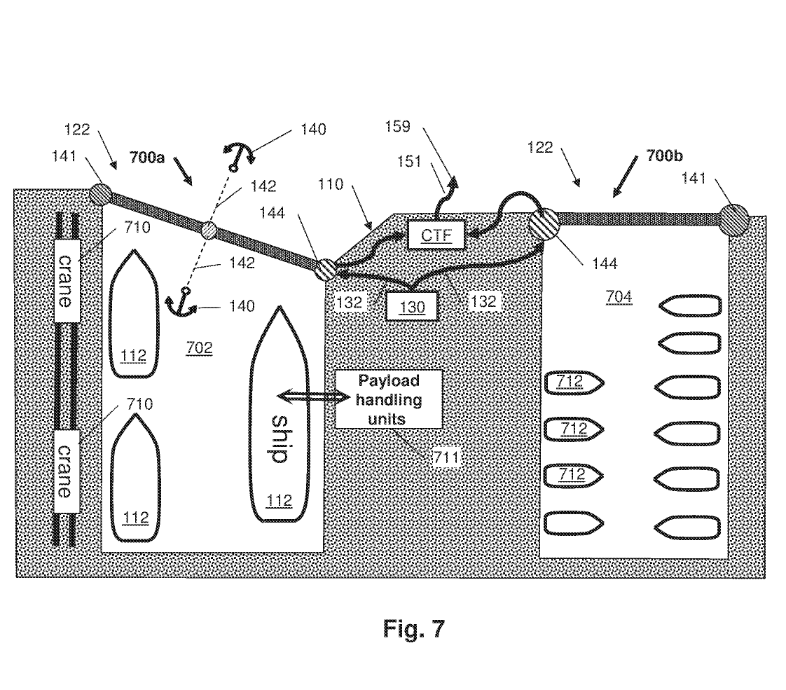

FIG. 7 schematically depicts view of a marine barrier s 700a and 700b installed in an entrance to a harbor 702 or a marina 704 or any kind of marine asset that suitable to this kind of platform (e.g. oil terminal), according to an exemplary embodiment of the current invention.

When used at the entrance or a gate to a harbor 702 or a marina 700b, both ends of the barrier 700a or 700b may be anchored to the docks. However, optionally other anchoring means such as anchors 140 may be used.

For demonstration purposes, the harbor 702 depicted here is seen with cranes 710 and payload handling units 711 for loading and/or discharge of packaged goods such as boxes and containers; bulk goods such as coal, grains, and fluids such as gas, fuel and the likes. For demonstration purposes, the marina or any kind of marine asset that suitable to this kind of platform (e.g. oil terminal) 704 is seen with boats 712.

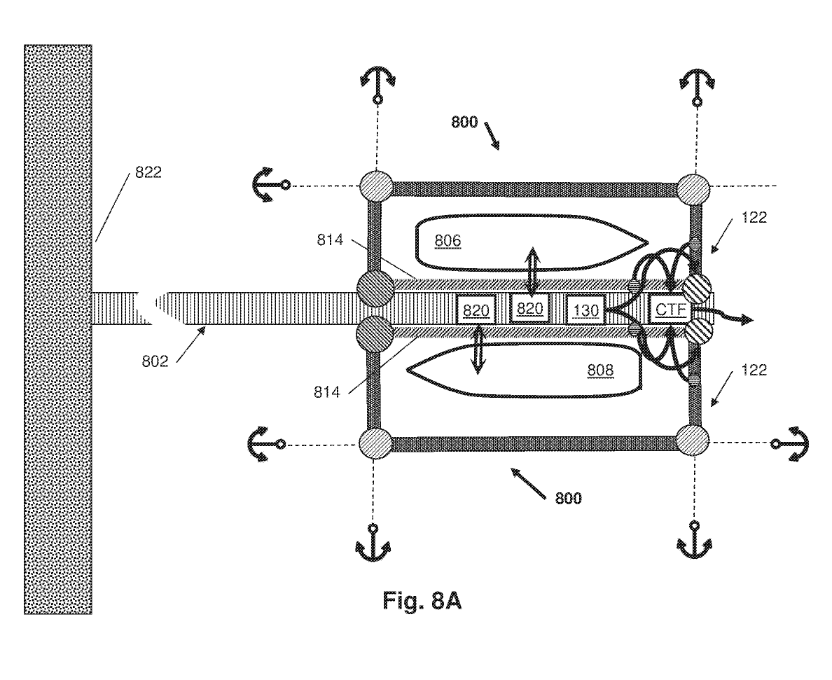

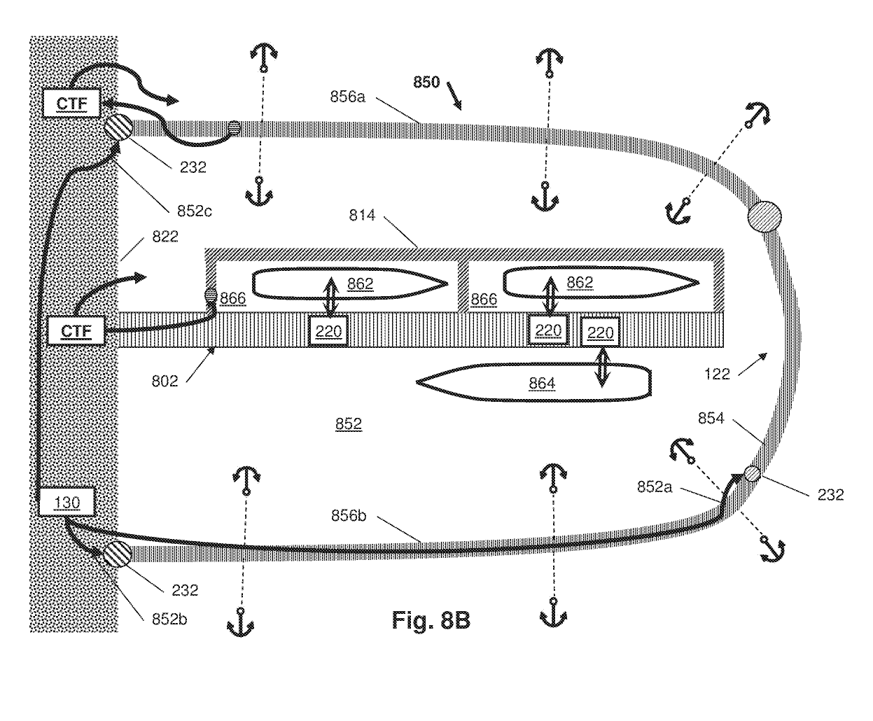

FIG. 8A schematically depicts a top view of a marine barrier 800 installed around a jetty 802 according to an exemplary embodiment of the current invention.

The marine barrier may be used around a jetty/terminal/marine asset 802, extending from the shore 822, such as used for loading and/or discharge of any kind of payload, for example coal, oil, fuel, water or gas. It is common to have docking spaces on both sides of the jetty and thus the marine barrier 800 is installed to protect both sides.

Optionally, a floating spillage collection pipe or skimmer 814 is installed near the jetty 802 to collect spillage that may leak from the anchored ship such as tanker 806 or bulk ship 808 or any kind of vessel, manifold or pipe install on the marine asset. In the example depicted here, two spillage collection pipes 814 are seen, one on each side of the jetty. However a single spillage collection pipe 814 may be used, for example on one side or under the jetty, for example on the side dedicated for payload loading and/or discharge. Floating spillage collection pipes and skimmer are known in the art. However, a light, small diameter barrier version of the barrier seen here may be used.

The depicted jetty seen here with a payload handling units 820 for loading and discharge tanker 806 and bulk ship 808 or any kind of vessel or pipe install on the marine asset 802.

FIG. 8B schematically depicts a top view of a marine barrier 850 installed around a marine asset such as jetty 802, protecting a large section of sea 852 according to yet another exemplary embodiment of the current invention.

Optionally, a large area of sea may be protected by a barrier 850 installed around the marine asset 802. Optionally, the barrier is anchored to the shore 822 and protects the entire marine asset 802.

Pneumatics 130 may separately controls the floating and submerging of controlled entrance 122 via air line 852a connected to the section 854 used as controlled entrance at pneumatics barrier interface 232. Submerging the section 854 may be done frequently to open the controlled entrance 122 any time a floating body needs to enter or exit the protected section of sea 852. Optionally, air hose 852a is strung within the lumen of one of the pipes used to construct the barrier 850 (for example its body or its main body), or is attached to the barrier 850.

Other parts 856a and 856b of barrier 850 are preferably separately controlled by the same or a separate pneumatics units(s) 130 for example via hoses 852b,c,d and can be used as controlled entrance as well.

In the depicted embodiment, a CTF is connected to barrier 850. Optionally, additionally, or alternatively, a floating spillage collection device (e.g. pipe) 814, connected to the same or a separate CTF, may be installed around anchored floating body (e.g. ships, vessels, pipes, manifold) 862 that present risk of spillage, to contain and collect spillage near its origin, before it spread over the entire

The floating spillage collection device (e.g. pipe) 814 may separate the protected zone into separate cells 866. Optionally, floating spillage collection device (e.g. pipe) 814 may be moved around according to need. Optionally some floating body (e.g. ships, vessels, pipes, manifold) 864 that do not present risk of spillage are not surrounded with floating spillage collection pipes.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A marine barrier comprising:
a body, said body is at least partially above water-level when the marine barrier is in floating state;
a main body, connected to said body and supporting said body;
at least one weight connected to the bottom of said main body and keeping the marine barrier upright; and
at least one floatation chamber at least partially full of gas when the barrier is in floating state, wherein the marine barrier is configured to at least partially submerge when water enters said at least one floatation chamber when the marine barrier is in submerged state and to return to floating state when gas is pumped into said at least one floatation chamber displacing water within said at least one floatation chamber, and wherein in said at least one floatation chamber is non-inflatable.

2. The marine barrier of claim 1, wherein at least one of: said body, said main body, and said at least one floatation chamber are made of extruded plastic material.

3. (canceled)

4. The marine barrier of claim 1, wherein said at least one floatation chamber is rigid or semirigid.

5. The marine barrier of claim 1 wherein said at least one floatation chamber further comprises a venting tube connected to the lower part of said at least one flotation chamber for venting excess gas when gas is pumped into said at least one floatation chamber.

6. (canceled)

7. (canceled)

8. The marine barrier of claim 1, wherein water used for flooding said at least one floatation chamber is water from the body of water where the marine barrier is positioned, and the gas used for discharging said water from said at least one floatation chamber is air.

9. (canceled)

10. The marine barrier of claim 1, having a plurality of multiple floatation chambers.

11. The marine barrier of claim 10, wherein at least two of said plurality of floatation chambers are attached to the marine barrier externally, and both sides of said main body.

12. (canceled)

13. (canceled)

14. The marine barrier of claim 10, wherein at least one of said floatation chambers is at least partially filled with non-fluid material which is lighter than water, and wherein said non-fluid lighter than water material is selected from the list consisting of: foam, closed-cell rigid foam and gas filled bubbles.

15. The marine barrier of claim 1, wherein when in floating state the marine barrier prevents floating spillage and floating debris from traversing the marine barrier.

16. The marine barrier of claim 1, further comprising at least one skimming pipe having a plurality of contaminant skimming openings for collecting floating contamination when the barrier is in said floating state.

17. (canceled)

18. The marine barrier of claim 16, wherein controlling the amount of water in said at least one floatation chamber is used for controlling the floatation of said marine barrier such that said at least one skimming pipe is substantially at water level while pollution is collected bay said at least one skimming pipe.

19. The marine barrier of claim 16, wherein said at least one skimming pipe is further used for dispensing pollution treatment material.

20. The marine barrier of claim 1, wherein said main body is full of water when the marine barrier is at floating state such that the marine barrier has a considerable mass and as a result of this mass the marine barrier is hard to push around.

21. The marine barrier of claim 1, wherein the marine barrier is configured to perform one of: detect, stop, delay, hinder and prevent intruders from traversing the marine barrier while the marine barrier is in floating state, while allowing floating bodies to traverse the marine barrier while at least part of the marine barrier is in submerged state.

22. The marine barrier of claim 21, wherein said body of the marine barrier further comprises intrusion preventing devices selected from a group consisting of: anti diver net, spikes, barbed wires, fence, slippery walls, warning signs and active intrusion preventing devices selected from the group consisting of: water cannon, horns and noise blasting devices.

23. (canceled)

24. (canceled)

25. The marine barrier of claim 21, further comprising active warning devices selected from the group consisting of: beacons, lights, audio device, energy pulse device and horns.

26. (canceled)

27. The marine barrier of claim 1, wherein said weight is selected from a group consisting of: a metal chain, a metal cable, a plurality of weights strung on a rope or a cable.

28. (canceled)

29. (canceled)

30. (canceled)

31. The marine barrier of claim 27, wherein said weight further provides tensile strength to the marine bather.

32. The marine barrier of claim 1, further comprising at least two anchor lines, wherein said at least two anchor lines are anchored to the seafloor; and at least one depth limiting weight, connected to the bottom of the barrier at the end of at least 25 one submerging line,
wherein the weight and buoyancy of the marine barrier is such, that when in submerged state, the marine barrier would stop descending when said at least one depth limiting weight rests on the seafloor.

33. (canceled)

34. (canceled)

35. (canceled)

36. (canceled)

37. (canceled)

38. (canceled)

39. (canceled)

40. (canceled)

41. (canceled)

42. The marine barrier of claim 1, further comprising at least two anchor lines, wherein said at least two anchor lines are anchored to the seafloor; at least two intermediate buoys anchored to the seafloor, wherein each of said at least two anchor lines connected to a corresponding one of said at least two intermediate buoys, such that when in submerged state, the marine barrier would stop descending and would stay suspended by said at least two anchoring lines above the seafloor.

43. The marine barrier of claim 1, further comprising a control unit for controlling the state of the marine barrier, wherein said control unit is used for submerging at least one selected section of the marine barrier such that said at least one selected section of the marine barrier is used as a controlled entrance to a protected zone enclosed by the marine barrier.

44. (canceled)

45. (canceled)

46. (canceled)

47. (canceled)

48. (canceled)

49. (canceled)

50. (canceled)

51. (canceled)

52. (canceled)

53. (canceled)
